(19) United States
(12) Patent Application Publication
(10) Pub. No.: US 2026/0101073 A1
(43) Pub. Date: Apr. 9, 2026

(54) SYSTEM AND METHOD FOR IDENTIFYING CONTEXTUAL INFORMATION IN STREAMING CONTENT

(71) Applicant: ACK Ventures Holdings, LLC, Boca Raton, FL (US)

(72) Inventors: Eric Hoffert, New York, NY (US); Alexander Krassel, Encino, CA (US); David Naffis, New York, NY (US); Serhii Pyrozhenko, Kharkiv (UA); Serhii Postupaiev, Warsaw (PL); Oleg Garanin, Limassol (CY)

(21) Appl. No.: 19/355,809

(22) Filed: Oct. 10, 2025

Related U.S. Application Data
(63) Continuation-in-part of application No. 18/913,634, filed on Oct. 11, 2024.
(60) Provisional application No. 63/544,788, filed on Oct. 19, 2023.
(60) Provisional application No. 63/705,826, filed on Oct. 10, 2024.

(51) Int. Cl. H04N 21/238; H04N 21/234

(52) U.S. Cl. CPC H04N 21/238; H04N 21/23424

(57) ABSTRACT

Systems and methods for identifying contextual information in streams of content being delivered by streaming platforms are discussed. In response to a request for additional content, streaming content is examined for relevant contextual information that occurs close in time to upcoming scheduled breaks. The identified contextual information may be used to insert additional content in the stream of content. Techniques for determining and applying a ratio for the handling of requests amongst multiple streaming platforms and a video ingestion and processing framework are also discussed.

### RELATED APPLICATIONS

This application claims the benefit of, and priority to, U.S. Provisional Patent Application No. 63/705,826, filed Oct. 10, 2024, entitled “System and Method for Identifying Contextual Information in Streaming Content”, and is a continuation-in-part application of U.S. patent application Ser. No. 18/913,634, filed Oct. 11, 2024, entitled “System and Method for Streaming Content Identification”, which claimed priority to U.S. Provisional Application No. 63/544,788 filed Oct. 19, 2023, the entire content of all of the above applications being incorporated herein by reference in their entirety.

### BACKGROUND

In recent years there has been a move away from the traditional model of delivering media via broadcast TV or closed ecosystems like linear cable or satellite TV to Over the Top (OTT) media services which deliver content directly to consumers via the Internet. OTT media services are delivered through streaming platforms that bypass the traditional broadcast, satellite and cable platforms. The content delivered by the streaming platforms may include both video on demand and select live channels of content.

There are a number of different video formats used by the streaming platforms to deliver streaming content including MPEG Dynamic Adaptive Streaming over HTTP (MPEG-DASH or DASH) and HTTP Live Streaming (HLS). Both DASH and HLS are adaptive bit rate techniques and work by dividing the stream of content into smaller segments delivered over HTTP. The segments are encoded before transmission by the streaming platform and decoded by the video/media player on the receiving device prior to display of the content.

### BRIEF SUMMARY

Embodiments of the present invention provide techniques for identifying contextual information in streaming content being delivered by a streaming platform. More particularly, embodiments provide techniques for identifying contextual information in the stream that can be used to deliver appropriate additional content to the streaming platform in response to a request for additional content. Embodiments map the time of the appearance of the contextual information in the stream against the time of the request for additional content related to an upcoming break in the stream. Contextual information close in time to the break can be used with pre-determined criteria to select appropriate additional content for delivery.

In one embodiment, a computing device-implemented method to identify contextual information in a stream of content being delivered by a streaming platform includes receiving at a server over a network a request for additional content that is suitable for insertion into a stream of content being delivered by a streaming platform to a user device. The method also includes downloading a stream of content corresponding to an identified program in the stream of content being delivered by the streaming platform. The method further includes identifying upcoming media file segments in the stream and identifying contextual information in one or more of the file segments. The method additionally includes storing a record of the identified contextual information that indicates a time of appearance of the contextual information in the stream of content and mapping a time window of a pre-determined duration starting at the time of the request against identified scheduled breaks in the upcoming media file segments. The method also includes determining whether contextual information exists for the stream for an upcoming break within the time window and delivering or facilitating the delivery of additional content to the requesting streaming platform using the stored contextual information when the contextual information exists within the time window.

In another embodiment, a system for identifying contextual information in a stream of content being delivered by a streaming platform includes one or more network-accessible storage locations holding additional content and a network-accessible computing device equipped with at least one processor. The network-accessible computing device includes an analysis module that when executed by the at least one processor is configured to receive a request for additional content for insertion into a stream of content being delivered by a streaming platform to a user device and download a stream of content corresponding to an identified program in the stream of content being delivered by the streaming platform. The analysis module is further configured to identify upcoming media file segments in the stream of content for the identified program, identify contextual information in one or more of the upcoming media file segments and store a record of the identified contextual information that indicates a time of appearance of the contextual information in the stream of content. Additionally the analysis module is configured to identify scheduled breaks in the upcoming media file segments, map a time window of a pre-determined duration starting at a time of the request against the identified scheduled breaks in the upcoming media file segments and determine whether stored contextual information exists for the stream of content for an upcoming break within the time window. The analysis module is also configured to deliver or facilitate the delivery of additional content from the one or more storage locations to the requesting streaming platform using the contextual information to satisfy the request for additional content when the stored contextual information exists within the time window.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts an exemplary environment suitable for practicing one or more embodiments of the present invention;

FIG. 2 is a schematic illustration of streaming content provided by a streaming platform in an embodiment;

FIG. 3A depicts exemplary advertising bid requests in an exemplary embodiment;

FIG. 3B depicts an exemplary network environment for handling an advertising bid request in an exemplary embodiment;

FIG. 4A depicts an exemplary sequence of steps to identify a stream of content being provided by a streaming platform when responding to a request to provide additional content in an exemplary embodiment;

FIG. 4B depicts an exemplary sequence of steps to handle an advertising bid request an exemplary embodiment;

FIG. 5 depicts an exemplary environment suitable for practicing one or more embodiments to identify contextual information in streaming content;

FIG. 6 depicts an exemplary sequence of steps to identify contextual information within a stream of content being provided by a streaming platform when responding to a request to provide additional content in an exemplary embodiment;

FIG. 7A depicts an exemplary sequence of steps to identify contextual information within a stream of content using a speech-to text-module in an exemplary embodiment;

FIG. 7B depicts an exemplary sequence of steps to identify contextual information within a stream of content using a natural language processing module in an exemplary embodiment;

FIG. 7C depicts an exemplary sequence of steps to identify contextual information within a stream of content using an object recognition module in an exemplary embodiment;

FIG. 7D depicts an exemplary sequence of steps to identify contextual information within a stream of content using a video-to-text module in an exemplary embodiment.

FIG. 7E depicts an exemplary sequence of steps to identify contextual information within a stream of content using a music recognition module in an exemplary embodiment;

FIG. 8A depicts an exemplary sequence of steps to identify contextual information in near real-time in live content in an exemplary embodiment:

FIG. 8B depicts the segmenting of live content into consecutive slices in an exemplary embodiment;

FIG. 8C depicts the segmenting of live content into overlapping slices in an exemplary embodiment;

FIG. 9A depicts an exemplary sequence of steps to apply a static throttling ratio threshold to a request for additional content based on contextual information in an exemplary embodiment; and

FIG. 9B depicts an exemplary sequence of steps to apply a dynamic throttling ratio threshold to a request for additional content based on contextual information in an exemplary embodiment.

### DETAILED DESCRIPTION

The content being delivered by streaming platforms to a user's device may include breaks in the stream where additional content may be inserted for display. For example, the additional content may be relaxing videos such as nature scenes. The additional content may be public service announcements. Likewise, the additional content may be additional information related to the program being shown in the stream. The additional content may also be advertisements inserted into the stream. The streaming platform may request this additional content from a 3^{rd} party source. However, when requesting the additional content, the streaming platform frequently will not fully identify the program in the stream currently being viewed by the user. This presents a problem for the 3^{rd} party source of additional content who is seeking to provide appropriate additional content as some additional content may not be appropriate for particular programs and/or the additional content providers may have placed restrictions on where the additional content may be shown.

Embodiments of the present invention address this issue of determining appropriate content by providing techniques to identify the content a user is viewing (e.g.: a TV show or movie) by combining the incomplete data from a request for additional content from the streaming platform with other identified data. As used herein, the request data is incomplete in the sense that it doesn't fully identify the current content being viewed by the user with which the additional content is to be paired. To attempt to address this issue, embodiments use the information contained in the request in combination with other publicly available data listing the different streams/channels being provided by particular streaming apps. For example, in one embodiment, the other publicly available data may be gathered from a publicly available Electronic Programming Guide (EPG). The data that is provided in the request, such as the time of the request, and the genre and/or rating for the content being streamed, is compared to the EPG or other listing data on current video streams available to the streaming app of the user device receiving content. The comparison finds any channels on the particular streaming platform that are running a program at that time with that information (e.g. genre and/or rating). The manifest files or playlists associated with the identified streams are then examined to attempt to identify a channel within that subset of channels that has a scheduled break in the stream delivering the content that is near the time of the request. Manifest files and playlists are discussed in more detail further below. It should be appreciated that the techniques described herein provide a technical solution to a technical problem that exists only in distributed streaming environments as previous mechanisms for delivering content, such as conventionally providing content via cable TV providers, did not have to address the technical challenge of dynamically providing appropriate additional content while dealing with incomplete information regarding the show into which the additional content was to be inserted.

Currently, requests from publishers/streaming platforms for additional content do not include content data such as the show title, season, episode, or movie title. Publishers do not share this information with the additional content provider for various reasons such as economic and privacy reasons. The additional content provider on the other hand is seeking transparency to identify the content that the additional content is being paired with in order to ensure that appropriate content is provided in response to the request. In traditional linear/broadcast television, additional content providers providing content such as public service announcements, nature scenes, additional content related to the program and additional content in the form of advertisements are able to specify what programs they want to provide additional content against. With OTT media services, such as Free Ad Supported Television (FAST) services, the additional content providers are not usually afforded this same opportunity. Embodiments address this issue by using the partial data accompanying the request for additional content in combination with other publicly available data to dynamically determine the additional content to be provided to the requesting publisher/streaming platform.

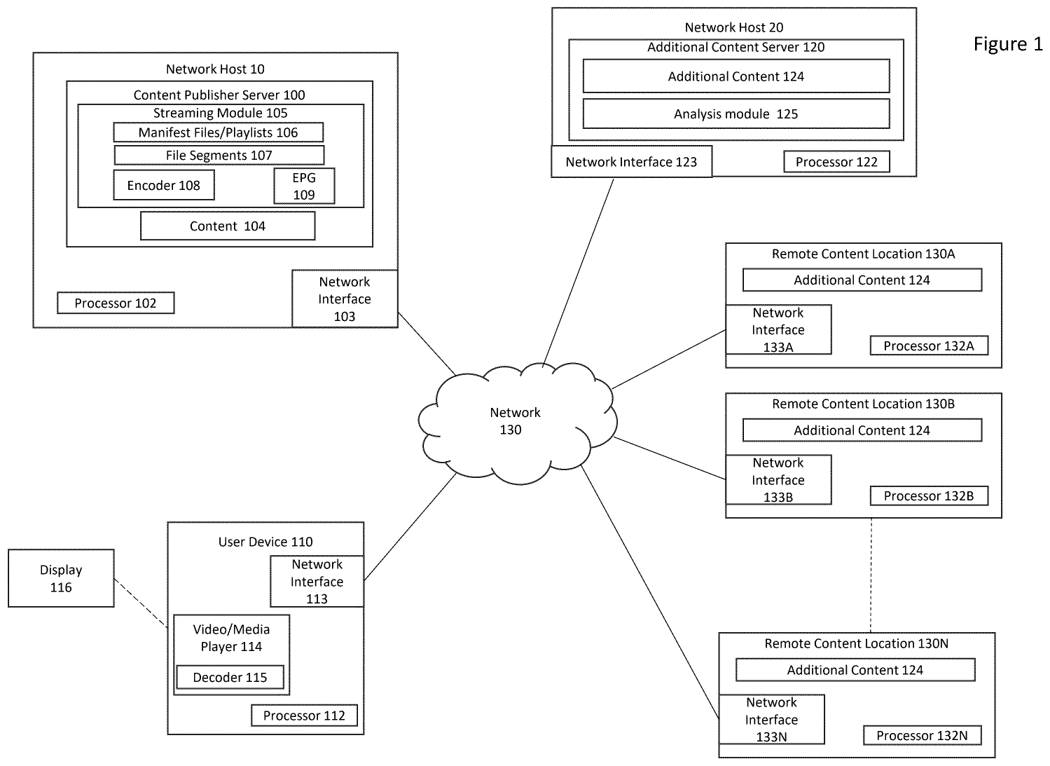

FIG. 1 depicts an exemplary environment suitable for practicing one or more embodiments of the present invention. A network host 10 hosts content publisher server 100 for a streaming platform and is equipped with one or more processor(s) 102. Content publisher server 100 stores, or provides access to, content 104. Content publisher server 100 includes streaming module 105 that when executed streams content 104 via network interface 103 and network 130 to user device 110. For example, network 130 may be the Internet, a cellular network, a wide area network, or some other type of network to which both network host 10 and user device 110 have access. Streaming module 105 segments content 104 into multiple file segments 107 and uses encoder 108 to encode file segments 107 for transmission. For example, in some embodiments, content 104 may be segmented and encoded to comply with the Dynamic Adaptive Streaming over HTTP (DASH) or HTTP Live Streaming (HLS) standards. It should be appreciated that content may be delivered via other formats other than DASH or HLS and the description of different embodiments herein referring to DASH or HLS should be understood to also include additional formats unless otherwise apparent from the context. The encoded streams may be transmitted as multiple adaptive bit rate streams as discussed further below.

Each stream of content being transmitted by the streaming platform has an associated manifest file/playlist 106 (depending on the format) that includes metadata and other information about the set of segments making up the stream that are read by video/media player 114 on user device 110 in order to properly display the streamed content. Content publisher server 100 and/or streaming module 105 may also provide an Electronic Program Guide (EPG) 109 to user device 110 listing information about the current and upcoming scheduled content being delivered to an app from the streaming platform. It should be appreciated that in alternate embodiments EPG 109 may be made available to the user of user device 110 from a different network accessible location rather than being provided directly from content publisher server 100 and/or streaming module 105.

User device 110 is equipped with one or more processor(s) 112 and receives an encoded stream of file segments 107 of content 104 via network interface 113 for an app receiving FAST services. Received file segments 107 and associated manifest files/playlists 106 are provided to video/media player 114. Decoder 115 in video/media player 114 uses the information in the manifest files/playlists to decode file segments 107 so they may be properly displayed to a user on display 116. Display 116 may be wired or wirelessly coupled to user device 110 or integrated into user device for displaying the decoded streamed content to a user. It will be appreciated that user device 110 may take many forms including, without limitation, smartphones, tablets, smart TVs, laptops, desktop computers and Internet connected TVs connected to network 130 in various ways including via the use of connectable network devices such as Roku® devices and Amazon Fire® sticks.

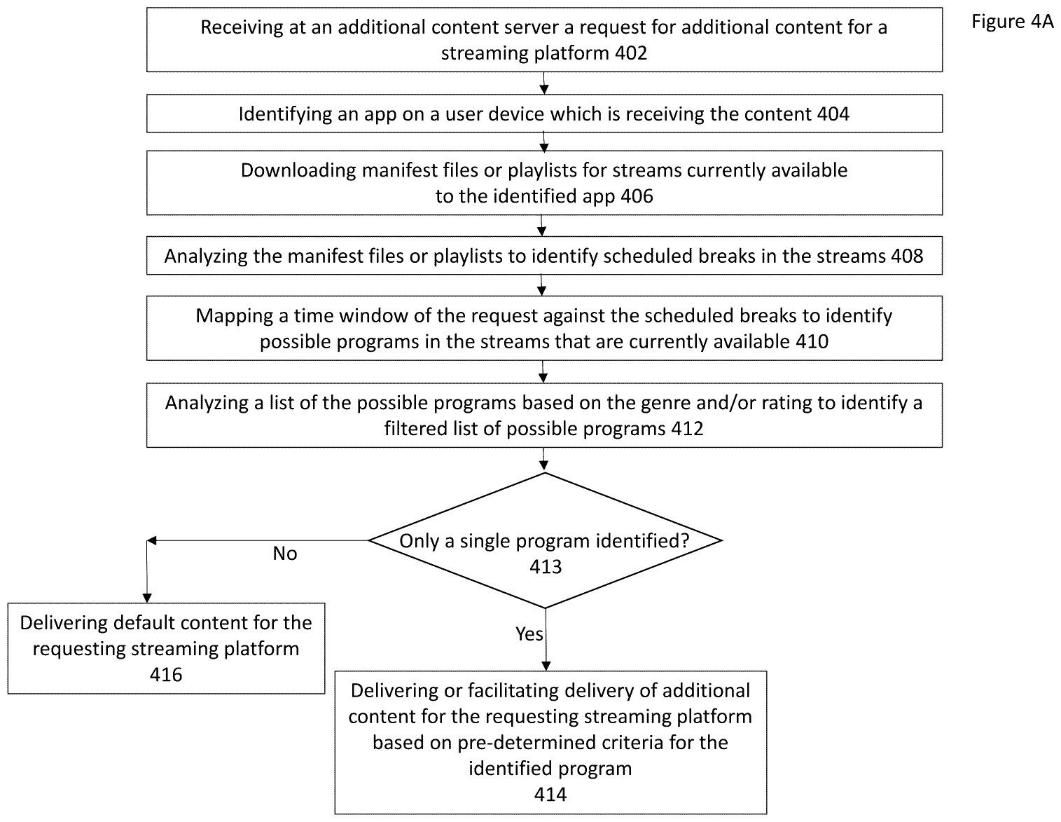

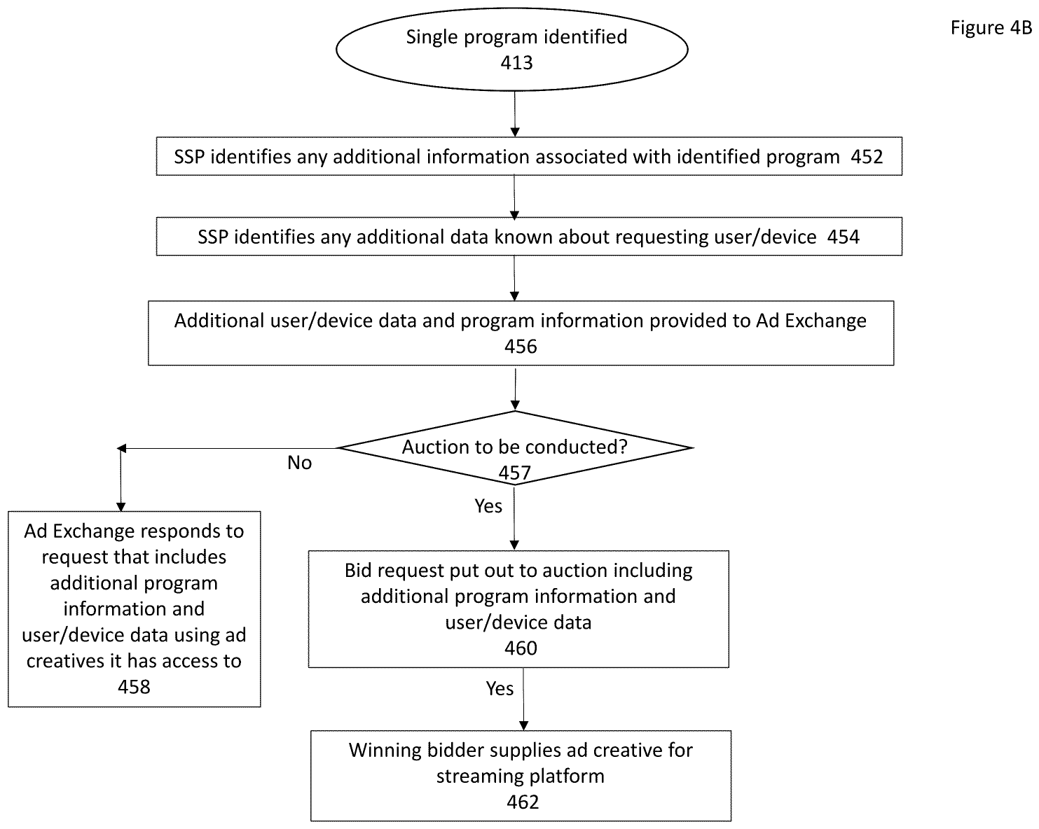

Network host 20 hosts additional content server 120 and includes one or more processor(s) 122. Additional content server 120 has access to, assists in the provision of, and/or stores additional content 124 and receives a request for additional content via network interface 123. In some embodiments, additional content server may include a Supply Side Platform (SSP). Additional content 124 may be stored remotely from additional content server 120 such as on one or more network-accessible remote locations, 130A, 130B . . . 130N, each of which may be equipped with one or more processors 132A, 132B . . . 132N and a network interface 133A, 133B . . . 133N. Additional content 124 may be provided by network-accessible remote locations, 130A, 130B and 130C and/or by additional content server 120. In some embodiments remote locations 130A, 130B and 130C may be an Ad Exchange, Ad Network or Demand Side Platform (DSP). Additional content 124 may be, without limitation, public service announcements, nature videos (e.g. relaxing nature scenes), additional information related to specific streaming content, and/or advertisements. In some embodiments, additional content server 120 includes analysis module 125. Embodiments utilize analysis module 125, which includes executable software instructions, to attempt to identify current content being streamed to a user by a streaming platform requesting additional content so that appropriate additional content may be displayed during stream breaks of that current content. Analysis module 125 performs at least some of the steps of FIGS. 4A and 4B and other functionality discussed in more detail below.

Content publisher server 100 and additional content server 120 may be implemented using hardware or software located on one or more network hosts that request/process requests for additional content sent over network 130. Content publisher server 100 and additional content server 120 may be provided via a computing platform that includes one or more processors such as, but not limited to one or more central processing units (CPUs), one or more graphical processing units (GPUs) and volatile memory such as random access memory (RAM). The computing platform may be, but is not limited to, a server, desktop computer, laptop computer, smartphone, mobile computing device, etc. and may be equipped with one or more flash devices. The computing platform may also include non-volatile storage such as a hard drive holding an operating system (OS) and non-volatile Read Only Memory (ROM) which may hold platform firmware and other data or instructions.

Adaptive bit rate streaming is a streaming technique that dynamically adjusts the presentation of video or audio data based on network conditions and device resources. Adaptive bit rate streaming first prepares the content for streaming by encoding the same content into different files at multiple different bitrates. Each file is split into smaller segments so the receiving video/media player can select an appropriate quality based on network conditions. A manifest file that describes the available stream segments and their bitrates is downloaded by the client device which then requests segments of an appropriate stream for the current network conditions. The media player will frequently switch between different bitrates as conditions change. This adaptive approach reduces buffering which allows the video/media player to deliver an optimal experience for the current conditions.

DASH was developed by the Moving Pictures Expert Group and for that reason is also referred to as MPEG-DASH. DASH is an international standard widely supported on client devices. The content in a multimedia file is partitioned into one or more segments. The segments are encoded at different bitrates and are compressed for delivery over HTTP to a receiving client device. A media presentation description (MPD) document (an XML document) provides information for a receiving media player about the available media content including the time of the media presentation, the different types of content, the different bitrates available and URLs to different media segments. The client uses the MPD information to request the transmission of appropriate audio or video segments.

HLS is a streaming communications protocol that was initially developed by Apple™ but is now supported by many devices beyond just the Apple™ ecosystem. Content is broken down into media segments which are stored as MPEG-TS or MP4 files. The segmenting of the content is performed at multiple bitrates by a segmenter/packager application (hereafter “segmenter”). The segmenter generates a set of playlist files that describe the media segments. These playlist files may be stored in the M3U8 format with each playlist associated with a specific bitrate and containing an URL to the segments for that specific bitrate.

The streams of segments that are delivered to the client media player may include markers, such as, but not limited to SCTE or cuetone markers indicating positions at which additional content may be inserted into the stream. As one example, SCTE-35 markers may be used to identify points where additional content can be inserted into media that is being delivered. SCTE-35 markers are attached to video stream samples as SCTE35 metadata. For HLS the SCTE-35 markers may be added to the playlist (M3U8) for each variant stream. For MPEG-DASH the markers may be added to the MPD as an eventstream element. Similarly, cuetones are sub-audible tones inserted in the stream that indicate points for insertion of content. In other embodiments, an ad break may be identified through the use of discontinuity tags or detecting changes in the URL (from content CDN to SSAI CDN).

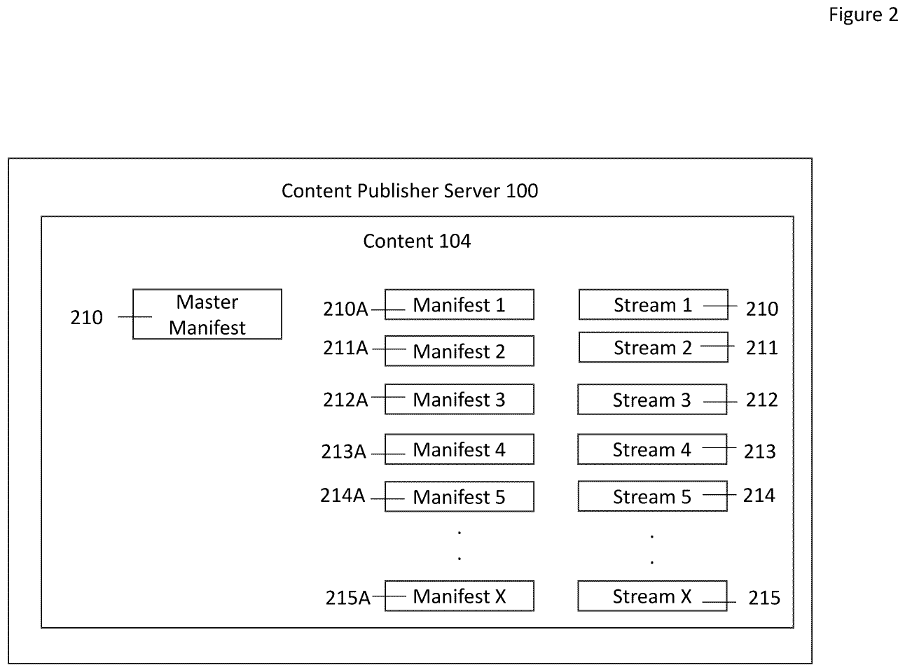

FIG. 2 is a schematic illustration of streaming content and related information provided by a content publisher server/streaming platform in an embodiment. A master manifest 210 indicates the different streams available at different bit rates. Each stream 210-215 provided by the streaming platform may be accompanied by its own manifest file 210A-215A or playlist depending on the technique being used to deliver the stream. The manifest file (or playlist) indicates where breaks occur in the stream and where additional content may therefore be inserted. These breaks are indicated in these streams through cuetones, scte35 markers, or other markers depending on the standard being used and embodiments may repeatedly download the manifest files or playlists of upcoming streaming content to identify when the breaks will occur.

Embodiments may identify appropriate additional content for insertion into streaming content despite an initial request for the additional content including incomplete identifying information. For example, in the case of a request for an advertisement, publishers/streaming platforms may send advertisement bid requests to a Supply Side Platform (SSP) for advertisements to be displayed during an upcoming stream ad break in a stream being delivered to a user device. The bid requests may include information about the app, sometimes including device info, user agent, and other signals that advertisers are interested in for targeting. However, publishers generally do not include content related information specific to what channel or show the user is watching. Often the only content related information is the genre (e.g. Action, Documentary, Comedy, Romance, etc.) and/or rating (e.g. G, PG, R, NR) of the program being watched. However, streaming platforms offering FAST services (e.g. Pluto TV™, The Roku Channel™, TUBI™, etc.) often have a publicly available Electronic Programming Guide (EPG) or other similar listing mechanism to publish information and embodiments may use its information, or equivalent sources of information, to supplement the request information. These FAST services resemble cable television, with an offering of channels with pre-scheduled content. The EPG is the guide to those channels indicating what is scheduled on each channel throughout the course of the day.

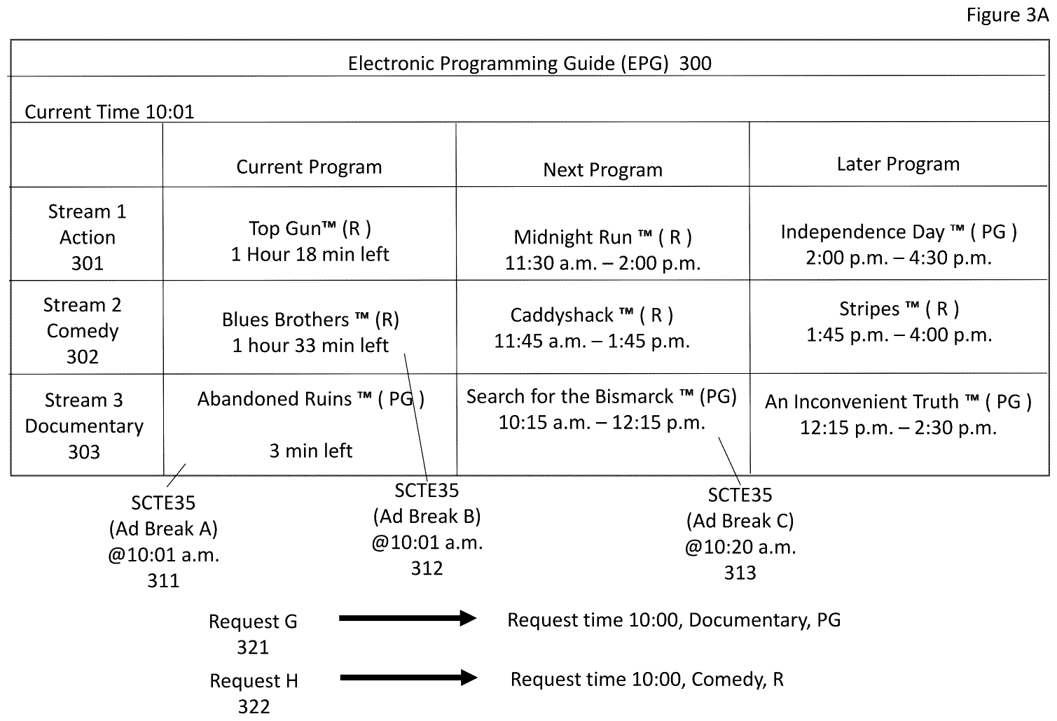

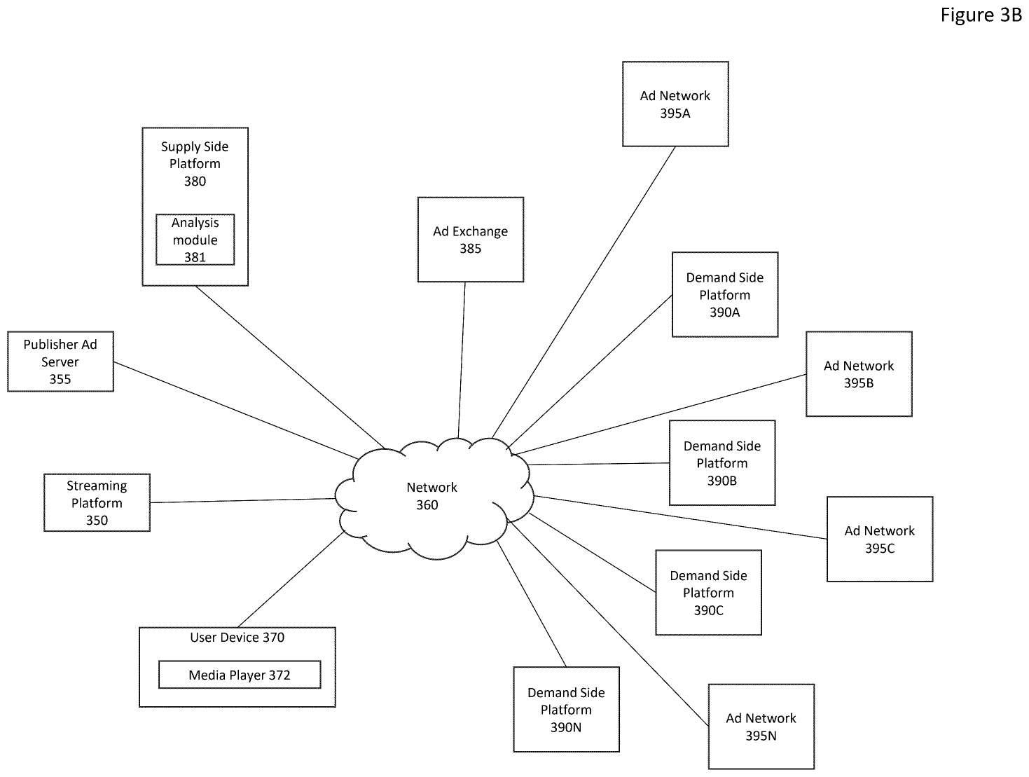

Embodiments leverage incomplete information in a request for additional content (incomplete in that it doesn't specifically indicate the program against which the additional content will be displayed) such as by leveraging the genre and/or rating information contained in a request along with analysis of the EPG in order to identify the specific program being viewed on the user device that will eventually receive the additional content. As noted above, in some embodiments, the request for additional content may be a request for an advertisement. FIG. 3A depicts handling of an advertising bid request in an exemplary embodiment using retrieved information from an EPG to supplement the bid request. As depicted, an exemplary EPG 300 shows three streams for a streaming platform. The first stream is a channel devoted to action movies (Action 301). The second stream is a channel that plays comedy movies (Comedy 302). The third stream is a channel showing documentaries (Documentary 303). The streams 301-303 may be streams delivered via HLS or DASH, or streams generated using another media standard. Each of the channels may have programming that is scheduled to appear in certain time slots.

The programs include ad breaks. For example, the program “Abandoned Ruins™” includes Ad Break A 311 scheduled to take place at 10:01 a.m. The movie “Blues Brothers™” includes Ad Break B 312 which is also scheduled to take place at 10:01 a.m. The program “Search for the Bismarck™” includes Ad Break C 313 scheduled to take place later at 10:20 a.m. These ad breaks are not visible or indicated in the EPG. They are however identifiable in the manifest files or playlists for the video stream (generally HLS, DASH, or some other standard). Ad breaks are indicated in these streams through cuetones, scte35 markers, or other markers depending on the standard being used. Each of these streams, and in particular their associated manifest files, is continuously downloaded and analyzed by the analysis module in the additional content server to look for ad breaks and the times of those ad breaks are recorded.

Continuing with the example of FIG. 3A, when the bid request is received, the analysis module notes the time the request was made and which app is receiving the content (the identity of the app is contained in the request). In some embodiments, the request includes a timestamp which is read by the analysis module. In another embodiment, the request time is estimated by the analysis module by identifying the time the request was received at the additional content server. In FIG. 3A, three bid requests are made, bid request G 321, bid request H 322, and bid request I 323 and the associated data analyzed by the analysis module includes the time of request, genre, and rating. To determine the program being watched, the analysis module compares the time of the bid request to streaming channels on the identified app through which the content is being delivered to (e.g. currently shown programs on Pluto TV™) that have an ad break near that time (determined via the times identified in the downloaded manifests) and narrow down the set of channels the user could be viewing. The bid request time may be up to a few minutes before the ad break in cases where ads are pre-fetched. Once a subset of candidate channels is determined by the analysis module, the genre and/or rating information from the bid request is used to determine which of the candidate channels matches. If there is any ambiguity (two candidate channels or more have the same genre and/or rating) then the bid request may be ignored for the purpose of show identification depending on pre-determined criteria for handling ambiguous results. For example, in such a case default generic content may be provided. When there is only one candidate channel after filtering for genre and/or rating, the channel data is then checked in the EPG by the analysis module to determine the name of the show scheduled at that time which indicates the channel and show being viewed by the user for the bid request. It will be appreciated that the use of both genre and rating by the analysis module in matching the request to the candidate channels will lead to a more accurate determination of the current program as opposed to the use of only one of genre and rating.

With respect to the example in FIG. 3A, bid request G 321 has a request time of 10:00, with a genre of Documentary, and rating of PG. As noted above the request time may be provided via an accompanying timestamp or determined by receipt time. The analysis module 125 looks at the video streams manifest files being downloaded and analyzes them to find any ad breaks that occur within a few minutes of 10:00 (the timestamp of the bid request), finding ad breaks A 311 and B 312 associated with Stream 3 (Documentary) 303 and Stream 2 (Comedy) 302 respectively (and ignoring ad break C 313 in Stream 3 (Documentary) 303 as too far away in time). The analysis module then determines which of Stream 2 302 and Stream 3 303 has programming airing at that point in time with a genre matching “Documentary” and rating of “PG” which were the genre and rating provided in the bid request. The analysis module narrows down the channel to Stream 3 (Documentary) 303 which is broadcasting the show “Abandoned Ruins” which has a scheduled ad break A 311 scheduled for 10:01. Additional content appropriate to that program may then be provided to the requesting streaming platform. Embodiments may thus offer advertisers and other content providers the ability to target specific programs to run their additional content against with increased certainty. The additional content providers can also be offered the ability to block specific programs provided by the streaming platforms that are not brand safe.

It should be appreciated that the vast majority of advertisements that people see online or when receiving FAST services are programmatically generated via programmatic bid requests and these bid requests frequently include an auction process. Publishers make their ad space inventory available with the aid of SSPs. The SSP provides information about the available ad space from the bid request coupled with any additional information known about the user gathered either from the bid request or gathered from external sources. Advertisers use Demand Side Platforms (DSPs) to purchase the available ad space setting various criteria in the form of what they are willing to pay and what attributes are desired for a target audience. In some cases, the advertisers may want ads shown against a specific program and in other cases they may want to avoid a specific program if it is not consistent for example with the brand being advertised in the creative. Ad Exchanges work as intermediaries between the SSPs and DSPs. Embodiments of the present invention provide an analysis module that provides additional information in the form of determining specific program identity that can be added to the bid request. In some embodiments, the analysis module may be part of the SSP which specifically identifies the program before attempting to process the request. In another embodiment, the analysis module may be part of an Ad Exchange that has received a bid request from an SSP without the specific program being identified and supplements the information from the bid request by adding the program identity to the request information e.g. before conducting an auction.

FIG. 3B depicts a network environment for handling an advertising bid request in an exemplary embodiment. A streaming platform 350 provides a stream of content over network 360 to media player 372 on user device 370. For example, streaming platform 350 may provide FAST services. In advance of an upcoming ad break, streaming platform 350 sends a bid request to Supply Side Platform 380 to obtain an ad creative to be inserted into the stream being delivered to user device 370. The bid request includes some information about the content being streamed (e.g. genre and/or rating) but doesn't explicitly identify the streamed content which makes filling the ad request with appropriate content difficult. However, as previously discussed, in some embodiments, an analysis module 381 may use the EPG data or similar data for the FAST programming being provided by streaming platform 350 in combination with the partial information contained in the bid request (i.e. information not definitively identifying the program being streamed) in order to identify the streamed content. The publisher/streaming platform may also supplement the bid request with additional information known about the user by its own ad server 355 or external sources. After the streamed content is identified, Supply Side Platform 380 can attempt to satisfy the request from its own sources of ad creatives or send the bid request for the identified program to an Ad Exchange 385 and/or one or more of DSPs 390A-390N and/or Ad Networks 395A-395 to provide the creatives. In some embodiments a Real Time Bidding (RTB) auction may be conducted to satisfy the request with the now identified program with the winning bidder supplying an ad creative for insertion into the stream provided by the streaming platform.

In some embodiments, further data can be queried once channel and show information is known including detailed descriptions of the program, actors and directors, ratings, and other metadata that is available through third party data sources. This channel and show information and associated metadata can then also be targeted for advertising by including the information in the bid request.

FIG. 4A depicts an exemplary sequence of steps followed by an embodiment of the present invention to identify a program on a streaming channel being provided by a streaming platform as part of a request to provide additional content. The sequence begins with an analysis module on an additional content server receiving a request for additional content from a streaming platform (step 402). In some embodiments the additional content server may include a supply side platform. The request may be timestamped or the receiving server may calculate the time it was sent based upon the time it was received. The request may be accompanied by a genre and rating for the content, or similar information, but is not accompanied by a name or identifier that definitively identifies the content being delivered. The app associated with the stream being delivered is indicated in the request and is identified by the analysis module (step 404). The analysis module repeatedly downloads manifest files or playlists for streams currently available on the identified app using a publicly available EPG or similar listing of programs on the app to identify the available streams (step 406). The manifest files or playlists are analyzed to identify scheduled breaks in the streams (step 408). The analysis module maps a time window of when the request was made against the scheduled breaks to identify possible programs in the streams that are currently available (step 410). A list of the possible programs is then filtered by the analysis module based on the genre and rating to identify a filtered list of possible programs (step 412). When this filtered list of possible programs contains only a single program (step 413), the additional content server delivers or facilitates the delivery of additional content for the requesting streaming platform based on pre-determined criteria (step 414). When this filtered list of possible programs does not contain only a single program (step 413), pre-determined criteria may dictate the delivery of generic default content for the streaming platform for insertion into the ad break.

As previously discussed, in some embodiments the request for additional content may be a request for an advertisement to be inserted into an ad break in a stream being delivered by the streaming platform. FIG. 4B depicts an exemplary sequence of steps to handle an advertising bid request an exemplary embodiment. Once a single program has been identified by the analysis module (step 413 in FIG. 4A) the sequence begins with the SSP identifying any additional information about the now-identified program and adding it to the bid request (step 452). The SSP may also attempt to identify any additional data about the requesting user/device receiving the streamed content (step 454). The additional program information and/or user/device data may be provided with the bid request to an Ad Exchange (step 456). If the bid request does not indicate that an auction is to be conducted (step 457), the Ad Exchange may attempt to fill and/or facilitate filling the request, which now includes the additional information and/or user/device data, using ad creatives to which it has access (step (458). In some embodiments, the Ad Exchange may control the ad creative. In other embodiments, the Ad Exchange may receive available ad creatives from DSPs or Ad Networks. If an auction is to be conducted (step 457), the bid request is put out for auction with the request including the additional information and/or user/device data (step 460) and the winning bidder supplies an ad creative for the streaming platform (step 462).

### Contextual Information Identification

In a further embodiment, once the identity of the streaming content has been determined whether as described above, or in another manner, contextual information may be identified that is associated with the streaming content and that contextual information may be used to respond to a request for additional content. In some embodiments, the analysis module downloads streams of identified content and analyzes segments of media files to identify contextual information within the stream using a variety of techniques. The identified contextual information may be stored along with an indication of where it occurred in the identified stream. The identified contextual information may be used to select content to respond to a request for additional content based on pre-determined criteria.

A variety of techniques may be used to identify the contextual information once the program being streamed to the user device has been identified and the corresponding stream downloaded. In some embodiments, The analysis module may include or utilize a number of different software modules for the analysis. In one or more embodiments, the modules include machine learning models or another type of artificial intelligence model. In one embodiment, the modules may include one or more of an object recognition module, a music recognition module, a speech-to-text module, a video-to-text module and/or a natural language processing module.

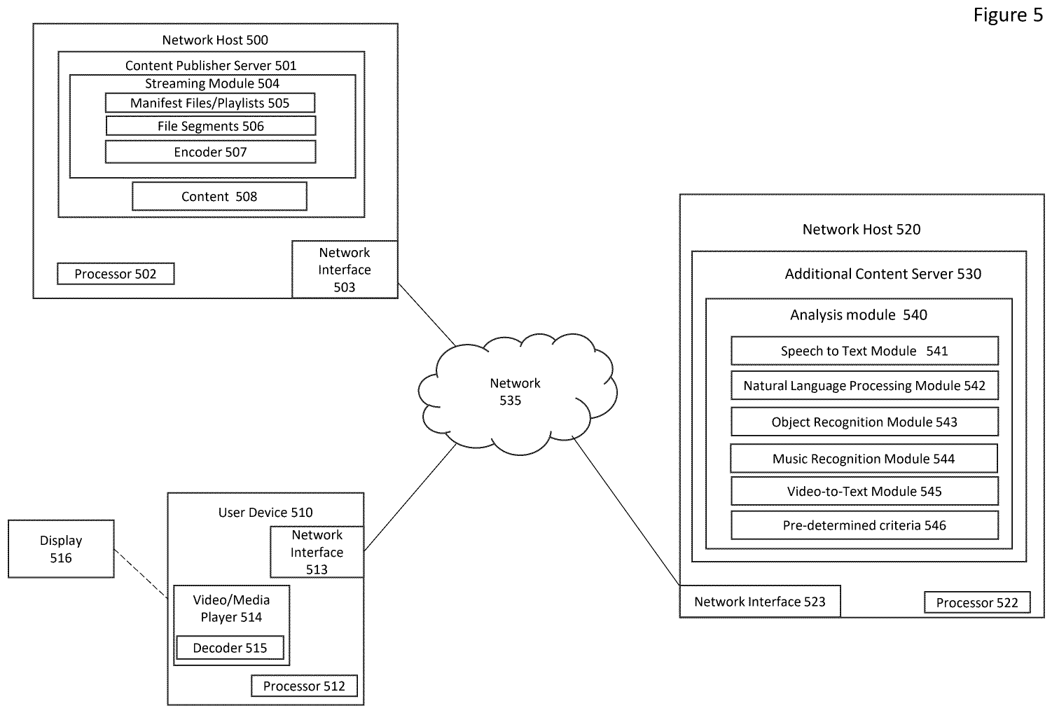

FIG. 5 depicts an exemplary environment suitable for practicing one or more embodiments to identify contextual information in streaming content in an exemplary embodiment. A network host 500 hosts content publisher server 501 for a streaming platform and is equipped with one or more processor(s) 502. Content publisher server 501 stores, or provides access to, content 508. Content publisher server 501 includes streaming module 504 that when executed streams content 508 via network interface 503 and network 535 to user device 510. For example, network 535 may be the Internet, a cellular network, a wide area network, or some other type of network to which both network host 500 and user device 510 have access. Streaming module 504 segments content 508 into multiple file segments 506 and uses encoder 507 to encode file segments 506 for transmission.

Each stream of content being transmitted by the streaming platform may have an associated manifest file/playlist 505 (depending on the format) that includes metadata and other information about the set of segments making up the stream that are read by video/media player 514 on user device 510 in order to properly display the streamed content.

User device 510 is equipped with one or more processor(s) 512 and receives an encoded stream of file segments 506 of content 508 via network interface 513. Received file segments 506 and associated manifest files/playlists 505 are provided to video/media player 514. Decoder 515 in video/media player 514 uses the information in the manifest files/playlists to decode file segments 506 so they may be properly displayed to a user on display 516. Display 516 may be wired or wirelessly coupled to user device 510 or integrated into user device for displaying the decoded streamed content to a user. It will be appreciated that user device 510 may take many forms including, without limitation, smartphones, tablets, smart TVs, laptops, desktop computers and Internet connected TVs connected to network 530 in various ways including via the use of connectable network devices such as Roku® devices and Amazon Fire® sticks.

Network host 520 hosts additional content server 530 and includes one or more processor(s) 522. Additional content server 530 has access to, assists in the provision of, and/or stores additional content and receives a request for additional content via network interface 523. In some embodiments, additional content server may include an SSP or Ad Exchange. Additional content may be provided by network-accessible remote locations and/or by additional content server 530. In some embodiments the remote locations may be an Ad Exchange, Ad Network or DSP. Additional content may be, without limitation, public service announcements, nature videos (e.g. relaxing nature scenes), additional information related to specific streaming content, and/or advertisements.

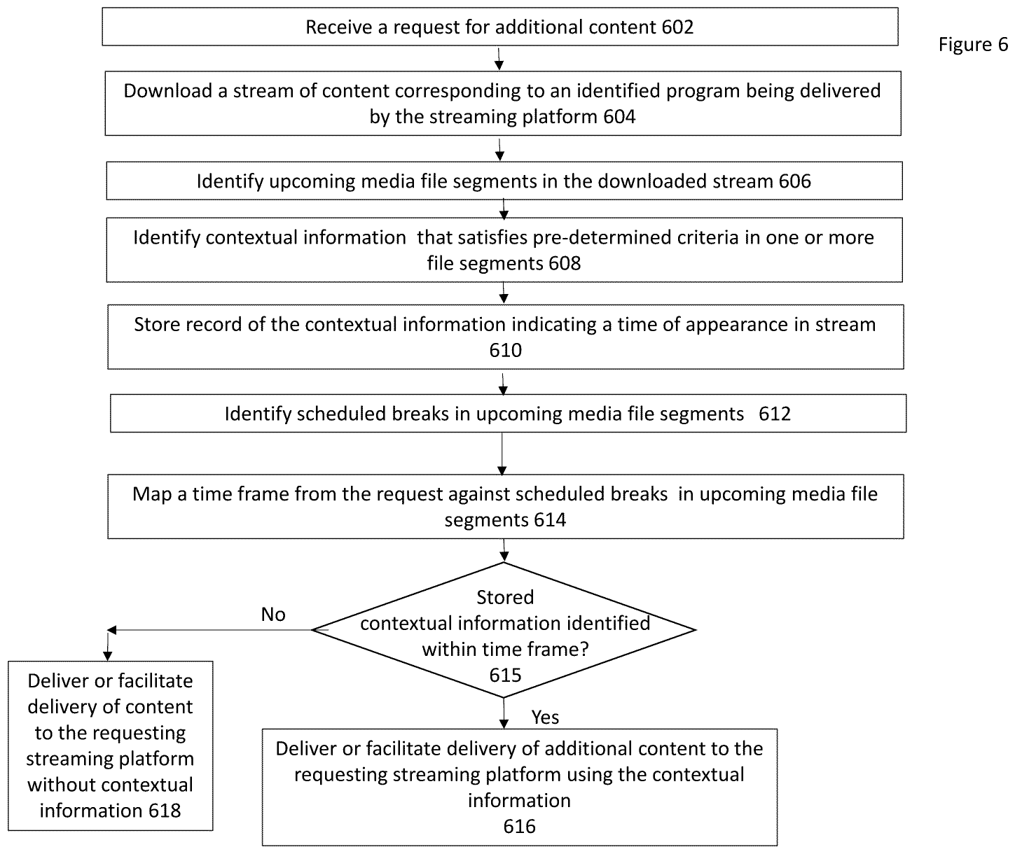

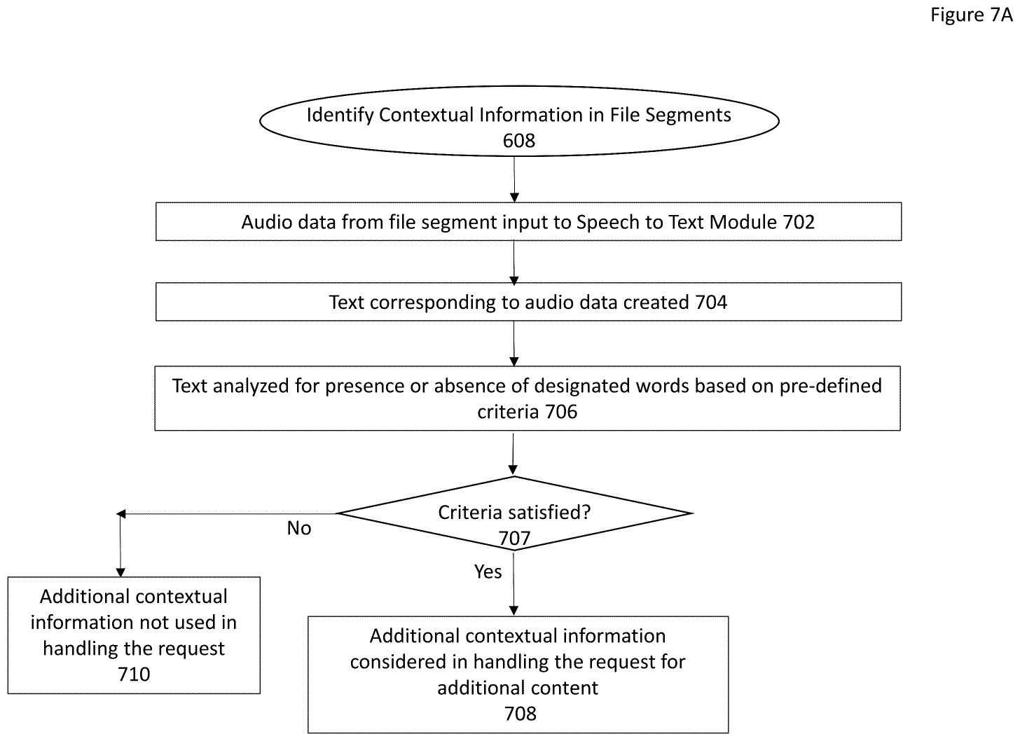

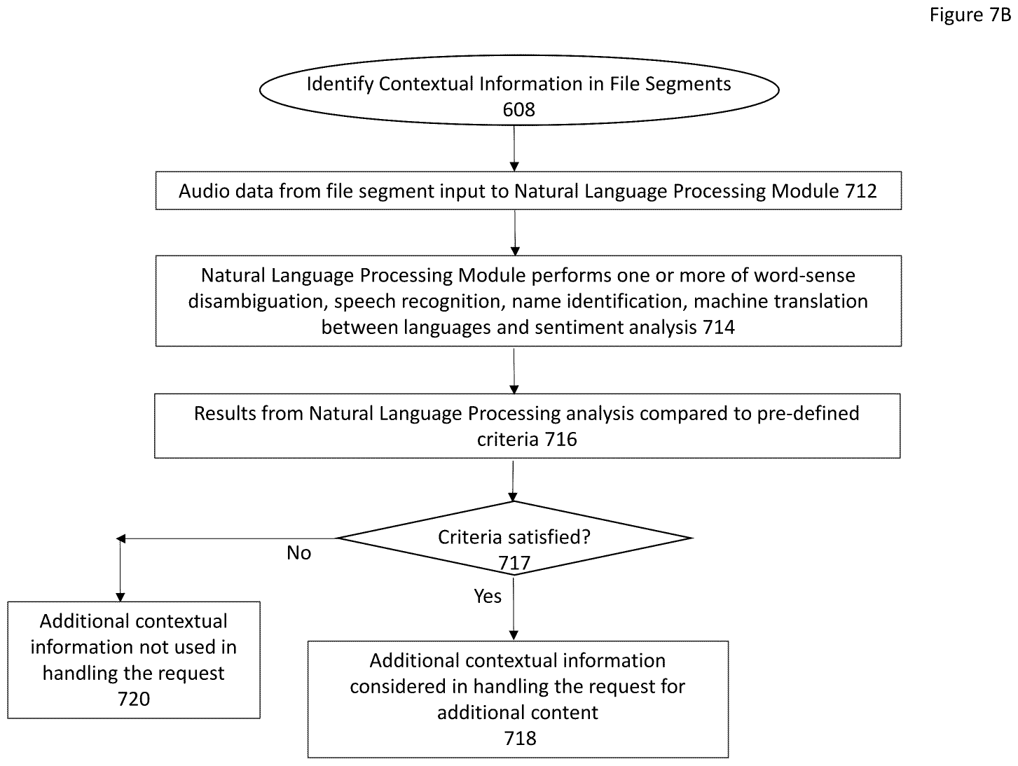

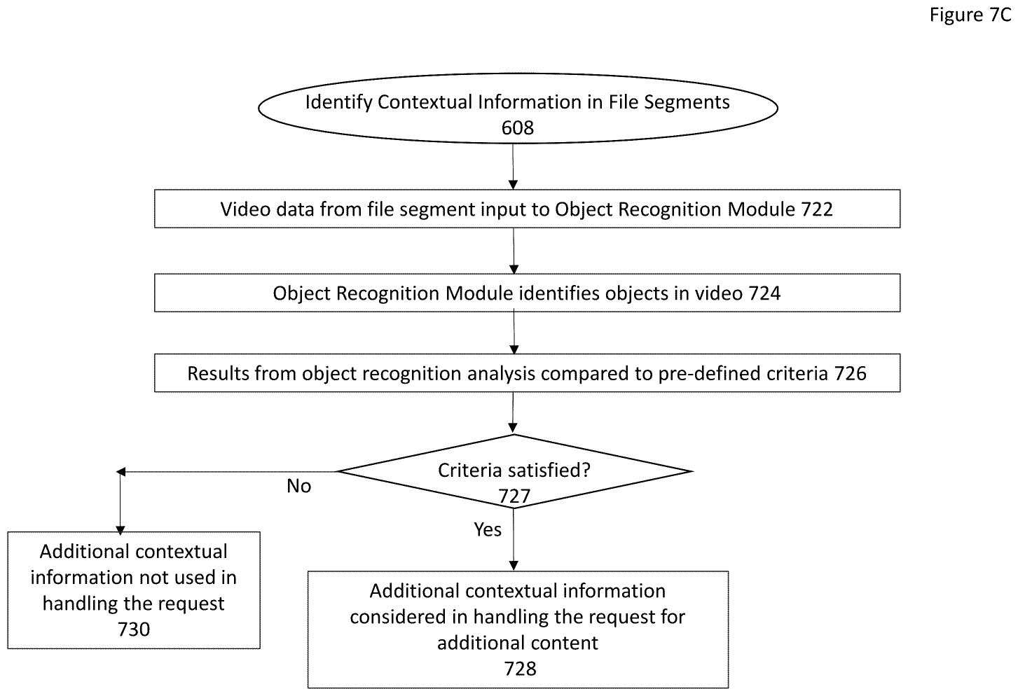

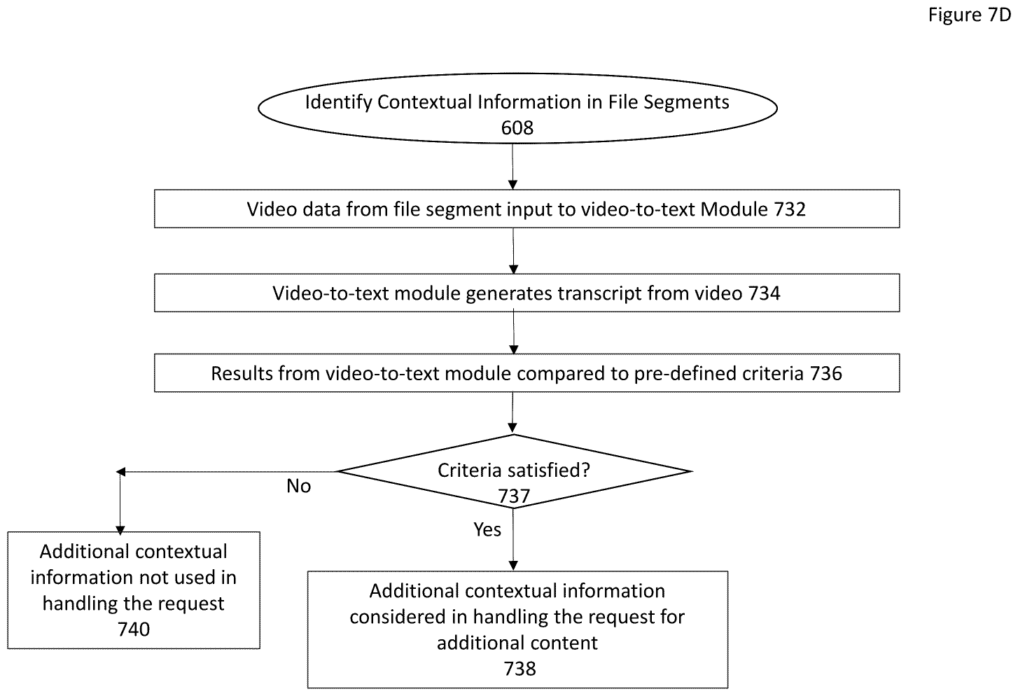

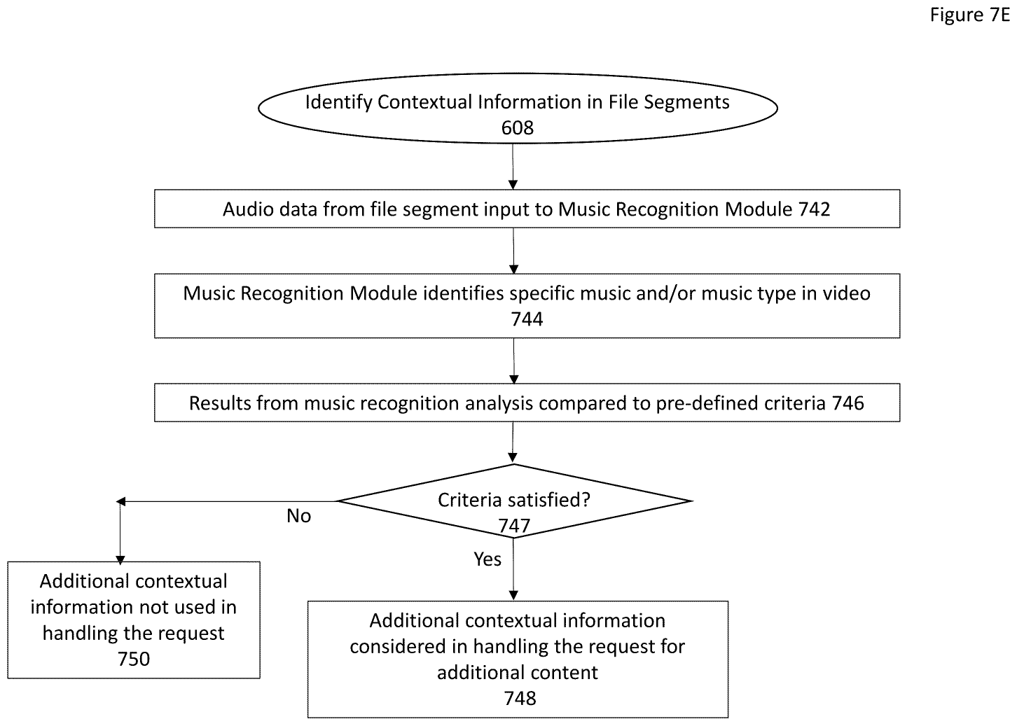

In some embodiments, additional content server 530 includes analysis module 540. Embodiments utilize analysis module 540, which includes executable software instructions, to attempt to identify contextual information in current content being streamed to a user by a streaming platform that is requesting additional content so that appropriate additional content may be displayed during stream breaks of that current content. Analysis module 540 performs at least some of the steps of FIG. 6 and FIGS. 7A-7E and other functionality discussed in more detail below. In some embodiments, analysis module 540 includes or works in concert with one or more of speech-to-text module 541, natural language processing module 542, object recognition module 543, music recognition module 544 and/or video-to-text module 545. Analysis module 540 may also include, or have access to, pre-determined criteria 546 that indicates what contextual information is relevant for a request.

For example, in some embodiments the file segments of a downloaded media file corresponding to the media files being streamed from the streaming platform to the user device may be analyzed by one or more modules. In some embodiments, audio information from the analyzed file segments is used to identify contextual information in the previously identified streamed content. For example, a Speech-to-Text module may be used to analyze audio data by converting the audio data to text and then determining whether the words in the text fit pre-determined criteria. In a further example, closed-captioning data may be analyzed. For example, the pre-determined criteria may indicate what additional content to retrieve based on the presence, absence and/or frequency of keywords. As a non-limiting example, text that includes various food types in the dialog may provide contextual information that results in additional content being selected that is an ad creative involving some type of food product. In a further example, if the dialog recites a competitors product, the pre-determined criteria may indicate that an ad creative for a competitor should not (or alternatively should) be provided as additional content if the mention is within a certain time period of the upcoming break for which the additional content is requested.

In one or more embodiments, audio data from the analyzed file segments may be input to a natural language processing (NLP) module. The NLP module may perform one or more of word-sense disambiguation, speech recognition, name identification, machine translation between languages and sentiment analysis. The output of the NLP processing may be compared against pre-determined criteria such as the presence, absence and/or frequency of keywords in order to select additional content that is appropriate

In some embodiments, music contained within the stream may be analyzed using a music recognition module that is a trained machine learning model. The music recognition module may, for example, attempt to identify a sentiment conveyed by the type of music being played in the media file segment (e.g.: sad, upbeat). For example, the pre-determined criteria may indicate that additional content of an upbeat nature should not be provided for an upcoming break in the stream being delivered to the user device that occurs immediately after a death scene in the streaming content that is accompanied by mournful music. In other embodiments, the music recognition module may be trained to recognize specific songs.

In some embodiments, video file segments may be analyzed. For example, in one embodiment an object recognition module may analyze video file segments in order to determine the presence or absence of certain specific objects or types of objects. In another embodiment, AI-based video-to-text methodology may be used to generate meaningful keywords describing non-verbal scenes or scenes with limited conversation, including martial arts scenes, gun battle scenes, car chase scenes, love scenes, etc.

FIG. 6 depicts an exemplary sequence of steps to identify contextual information within a stream of content being provided by a streaming platform when responding to a request to provide additional content in an exemplary embodiment. The sequence begins with the receipt of a request for additional content to be inserted into streaming content being delivered from a streaming platform to a user device (step 602). In some embodiments, this request does not initially identify the specific program being streamed but the program is subsequently identified using the technique described in FIG. 4A or a similar process. The sequence continues by downloading a corresponding stream of content corresponding to the stream being delivered by the streaming platform (step 604). In some embodiments, the corresponding stream is downloaded after the request for additional content is received. In other embodiments the corresponding stream is downloaded in advance, analyzed and the contextual information saved before the request is received. The sequence continues with identification of the media file segments in the downloaded stream (step 606). In some embodiments, the individual file segments are identified via the manifest or playlist associated with the downloaded stream. A variety of techniques may then be used to identify contextual information in one or more file segments that satisfy pre-determined criteria such as but not limited to the presence and/or frequency of certain keywords (step 608). The identification of contextual information in the media file segments is discussed in more detail below. The exemplary sequence then stores a record of the contextual information that indicates the time of its appearance in the stream (step 610). Scheduled breaks in the upcoming media file segments are identified as described herein (step 612). For example the breaks may be identified via SCTE-35 markers. The sequence continues by mapping a time frame starting from the time of the request against the identified scheduled breaks in upcoming media file segments (step 614). It is then determined if stored contextual information is indicated to occur in the media file segment within the mapped time frame in the stream (step 615). If so, the contextual information may be used in responding to the request for additional content by the requesting streaming platform (step 614). If stored contextual information has not been identified for the relevant time period near in time to the upcoming streaming break that resulted in the request, (step 613), the request may be handled without the use of contextual information (step 614).

The sequence described above in FIG. 6 may be further optimized by attempting to determine whether the corresponding stream of content for the identified program is the same as a previously analyzed stream of content prior to downloading corresponding stream of content (step 604 above). For example, in one embodiment the manifest data for the corresponding stream of content for the identified program is compared with manifest data for the previously analyzed stream. As a non-limiting example, the manifest URL, title and other EPG metadata such as genre and ratings, or other data may be compared. If the information is the same, the corresponding stream of content does not need to be downloaded again. If the comparison shows differences, the corresponding stream of content is downloaded (step 604). By performing a check of the manifest prior to downloading the corresponding stream of content and omitting the downloading when not necessary, network traffic is lessened and less processing is required to be performed by the analysis module with the result that the the request for additional content can be responded to in a quicker and more efficient fashion.

A comparison of manifests may not always determine whether a stream has been previously been downloaded and analyzed for contextual information since streamers may switch Content Delivery Networks (CDNs) (networks of distributed servers that store copies of content at geographically located sites to accelerate delivery of content and minimize physical distance to the user) or Server Side Ad Insertion (SSAI) servers (providing ad insertion directly into the stream at the server), or want to refresh streams for another reason. As a result, the same content may look very different. Accordingly, in another optimization, once a stream has been downloaded, the contents of file segments of the stream may be analyzed to determine if it is the same as previously analyzed file segments before analyzing it for contextual information. For example, a selection of file segments may be analyzed to determine if they contain break markers at the same points as previously processed file segments. If the comparison of the contents of the file segments reveals differences indicating the corresponding steam is different from the streams that have been previously processed, the corresponding stream may be analyzed for contextual information. By performing a check of the file segments prior analyzing them for contextual information and omitting the processing when not necessary, less processing is required to be performed by the analysis module with the result that the request for additional content can be responded to in a quicker and more efficient fashion.

Embodiments utilize a number of different techniques to identify contextual information within the media file segments corresponding to the stream content being delivered from the streaming platform to the user device. For example, FIG. 7A depicts an exemplary sequence of steps to identify contextual information within a stream of content using a speech-to-text module in an exemplary embodiment. The sequence beings with audio data from a file segment being input to a speech-to-text module (step 702). As noted above, the module includes executable software instructions and may be a trained machine learning model or other type of artificial intelligence model. The speech-to-text module converts the audio data to text and the text is parsed to identify its constituent words and phrases (step 704). The analysis module may analyze the text for the presence or absence of keywords or phrases based on pre-determined criteria as to what to identify (step 706). If the output satisfies pre-determined criteria (step 707), the output is contextual information that is considered in handling the request for additional content (step 708) such as an advertising bid request or other request for content. For example, the presence of a particular consumer product being recited in the dialog that is converted to text may be contextual information added to information associated with a bid request that results in additional content being delivered that is related in some manner to those products. The additional content might be for example, an advertisement for the same type of car referenced in the dialog that has been converted to text (e.g. a Ford Mustang™ is mentioned and an ad creative for a Ford Mustang™ is then provided based on that contextual information as additional content for an upcoming ad break). Alternatively, the additional content might be, for example, an advertisement for a different type of car than that referenced in the dialog. Similarly, in a non-advertisement context, if the additional contextual information is dialog related to sunsets and that information is added to a request for additional content, the additional content may be a video of a relaxing nature scene, such as a waterfall or a beach scene. In the event the output of the speech-to-text module does not satisfy pre-determined criteria, contextual information is not used in handling the request for additional content (step 710).

Similarly, FIG. 7B depicts an exemplary sequence of steps to identify contextual information within a stream of content using a natural language processing module in an exemplary embodiment. The sequence beings with audio data from a file segment being input to a natural language processing module (step 712). As noted above, the module includes executable software instructions and may be a trained machine learning model or other type of artificial intelligence model. The NLP module performs one or more of word-sense disambiguation, speech recognition, name identification, machine translation between languages and/or sentiment analysis (step 714). The results from the NLP module operation may be compared by the analysis module against pre-determined criteria to aid in the provision of additional content (step 716). If the output satisfies pre-determined criteria (step 717), the output is contextual information that is considered in handling the request for additional content (step 718). In the event the output of the NLP module does not satisfy pre-determined criteria, contextual information is not considered in handling the request for additional content (step 720).

FIG. 7C depicts an exemplary sequence of steps to identify contextual information within a stream of content using an object recognition module in an exemplary embodiment. The sequence beings with video data from a file segment being input to an object recognition module (step 722). As noted above, the module includes executable software instructions and may be a trained machine learning model or other type of artificial intelligence model. The object recognition module performs object recognition processes to identify objects in the video and/or frames of the video using any of a number of known techniques (step 724). The results from the object recognition module operation may be compared by the analysis module against pre-determined criteria to aid in the provision of additional content (step 726). If the output satisfies pre-determined criteria (e.g. the presence or absence of certain previously specified objects in the video) (step 727), the output is contextual information that is considered in handling the request for additional content (step 728). For example, if a specific actor is identified additional information related to the actor may be provided in an upcoming break. In the event the output of the object recognition module does not satisfy pre-determined criteria, contextual information is not considered in handling the request for additional content (step 730).

FIG. 7D depicts an exemplary sequence of steps to identify contextual information within a stream of content using a video-to-text module in an exemplary embodiment. The sequence beings with video data from a file segment being input to a video-to-text module (step 732). As noted above, the video-to-text module includes executable software instructions and may be a trained machine learning model or other type of artificial intelligence model. The video-to-text module analyzes video and produces textual description of the video that can also produce meaningful keywords that can complement speech-to-text based keywords. It should be appreciated that speech-to-text is best used for dialog, and video-to-text is best used for non-verbal scenes or scenes with only a few words such as action, gun battle, car chases, love scenes, etc. More particularly, the video-to-text module generates a transcript from the video (step 734) which may be used to identify the presence of keywords which are compared by the analysis module against pre-determined criteria to aid in the provision of additional content (step 736). If the identified keywords in the transcript satisfy pre-determined criteria (e.g. the appearance and/or frequency of appearance of a keyword in the transcript for the file segment) (step 737), the keywords are contextual information that is considered in handling the request for additional content (step 738). In the event the output keywords of the video-to-text module do not satisfy pre-determined criteria, contextual information is not considered in handling the request for additional content (step 730).

FIG. 7E depicts an exemplary sequence of steps to identify contextual information within a stream of content using a music recognition module. The sequence beings with audio data from a file segment being input to a music recognition module (step 732). As noted above, the module includes executable software instructions and may be a trained machine learning model or other type of artificial intelligence model. The audio data may include any available soundtrack data. The music recognition module compares the soundtrack data to known music types and/or specific music songs to identify the type of music and/or the specific track of music (step 734). For example, the music recognition module may be a trained machine learning model that has been trained to identify music by category (e.g. rock, rap, classical, etc.) and/or tone (e.g. subdued, loud, etc.) and/or to identify specific tracks of music by individual artists. The results from the music recognition module operation may be compared by the analysis module against pre-determined criteria to aid in the provision of additional content (step 736). If the output satisfies pre-determined criteria (step 737), the output is contextual information that is considered in handling the request for additional content (step 738). For example, the presence of loud rock music in the video before a scheduled break for which content is requested may lead to an ad creative with similar tone being supplied. In the event the output of the music recognition module does not satisfy pre-determined criteria, contextual information is not considered in handling the request for additional content (step 740).

It should be appreciated that the modules described in FIGS. 7A-7E are exemplary in nature and offered for illustration purposes and additional types of analysis of the audio and/or video data in the media file segments in place of, or in addition to those described, may be performed in order to identify contextual information, and those additional approaches should be understood to also be within the scope of the present invention.

### Near-Real Time Identification of Contextual Information in Streaming Content

As noted above, in some embodiments, an entire stream of content may be downloaded and analyzed in advance of it being streamed to a user device. This allows the contextual information to be identified in advance so as to provide appropriate additional content at relevant portions of the stream. This approach works for streaming content that is streamed multiple times but does not work for live streamed content that is streamed only once since identifying contextual information at the completion of the stream is of little use when the stream is not being repeated. For example, sporting events and live news broadcasts will be different every time and cannot be analyzed in advance.

Accordingly, in another embodiment, the analysis module described herein processes live video content being streamed in near real-time by assembling short slices of video content as the live digital video is being streamed, and performs speech-to-text, video-to-text or other types of analysis to identify contextual information, such as but not limited to keywords, for each slice immediately after a slice is assembled. It should be noted that discussions herein of analysis of “video” content frequently also include analysis of the corresponding audio content associated with the video content and any description of analyzing video content herein should be understood to encompass such audio analysis. This approach to process short slices as the video is being streamed allows contextual information to be identified for each slice of video content immediately after each slice of the digital video content has been streamed and appropriate additional content to be provided while it is still relevant to whatever is currently occurring in the live video content. For example, in one non-limiting example, an AI-based speech-to-text module and/or video-to-text module may be used to identify meaningful keywords in the live video content slice that may be used to retrieve contextual advertising immediately after the slice is analyzed.

Embodiments may analyze both pre-scheduled live digital video streaming (for example EPG-based viewing on a Connected TV device), and on demand viewership of video content streaming live (for example a sports game or a concert). For EPG-based streaming the analysis module may independently monitor all channels present in the EPG for a particular EPG provider. For example, the analysis module may obtain the content of the EPG via HTTP/HTTPS protocol over the Internet and analyze information about all channels defined withing the EPG. This may be repeated with sufficient frequency to detect changes in the EPG as the time progresses. A location of each stream (as an URL) for each channel is also obtained and the content of each channel may be retrieved independently of any viewer watching such content on their CTV or OTT devices.

For a specific channel when a start of a new program is detected (as defined in the EPG), if the program has been encountered in this provider's EPG before (i.e.: the program is a re-run of a TV show or a movie) there is no need to process it again because the meaningful contextual keywords have been generated for this program already. However, in one embodiment, if this program was encountered for the first time (a common occurrence for live sporting events, live news broadcasts, a first airing of a TV show or a movie, etc.), the “slice” collection may begin immediately. A slice of the streaming content is assembled for a predefined period (for example 2 minutes) where the segments of the streaming video are retrieved and collected into a slice of content of the predefine time (for example 2 minutes). Once a slice is assembled, it may be processed to identify contextual information. For example, as outlined above, a number of different modules may be employed to identify contextual information in the slice including but not limited to a speech-to-text module, video-to-text module, a natural language processing module, an object recognition module and/or a music recognition module. In some embodiments artificial intelligence models/machine learning models may be used to perform the analysis. For instance, in one non-limiting example, an AI-based speech-to-text model and/or an AI-based video-to-text model may be applied to the slice to generate a transcript for this slice. The transcript is used to generate a list of meaningful contextually significant keywords describing the slice so it can be contextually targeted with additional content such as additional information related to the content (e.g. actor information, release dates, production location, etc.) advertising, etc. based on the identified contextual information. This process may be repeated for each subsequent slice until the EPG program, or a live streaming event is over. For on demand streaming of live events slices are assembled and processed in the similar manner, with the difference that the Uniform Resource Locator (URL) to the streaming content may be obtained directly from the calling application running on a CTV or OTT device (e.g.: a Roku™, HULU™ or other app) and not the EPG. For example, a streaming service application may access an alternative streaming server instead of an original content management service and pass a Uniform Resource Indicator (URI) to the original content management service in such a call. As a result, the alternative streaming server may act as a proxy, intercepting the actual content delivery, so it can analyze the streaming content in near real-time, examining slices of content (as described herein) to generate contextual information about the content of the stream being delivered to the viewer that can be used to quickly deliver relevant additional content.

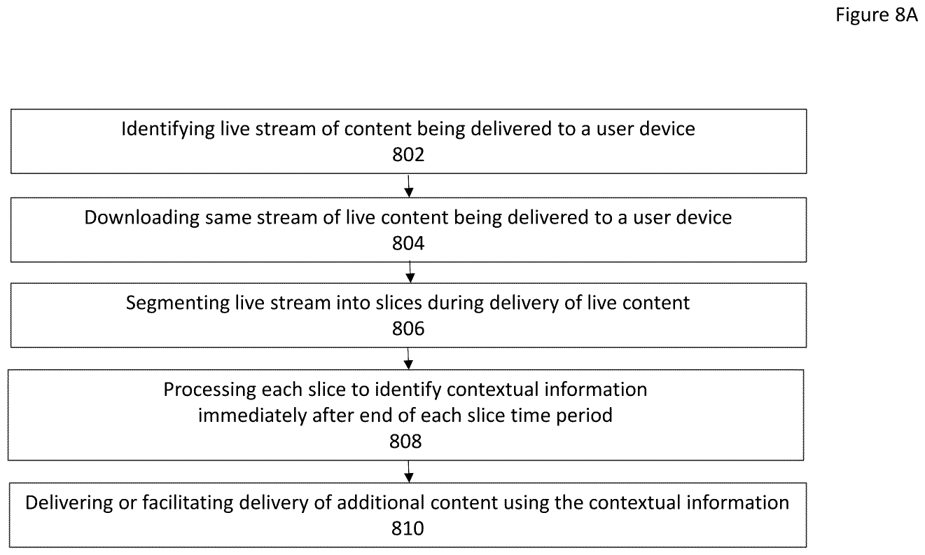

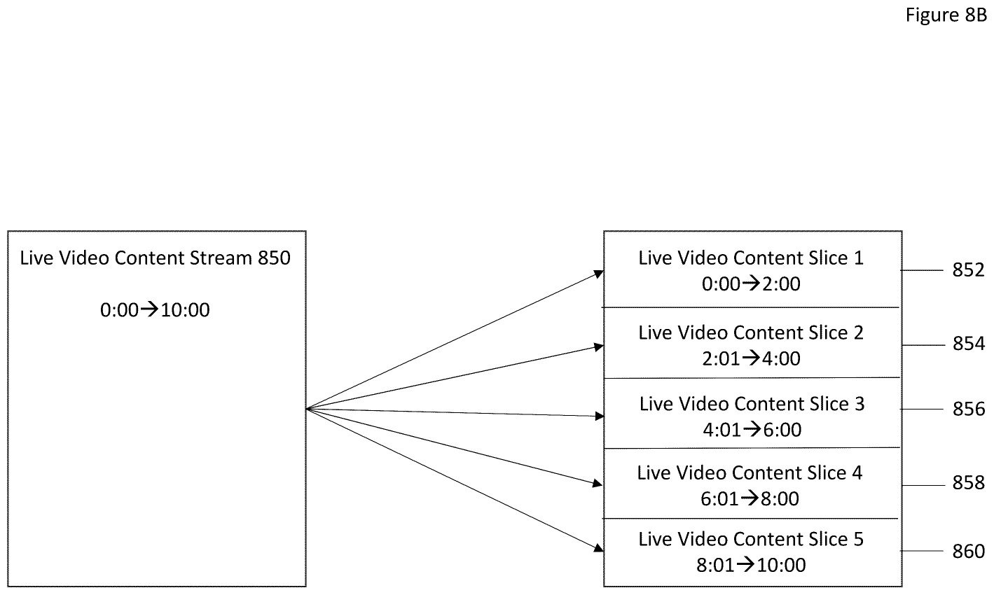

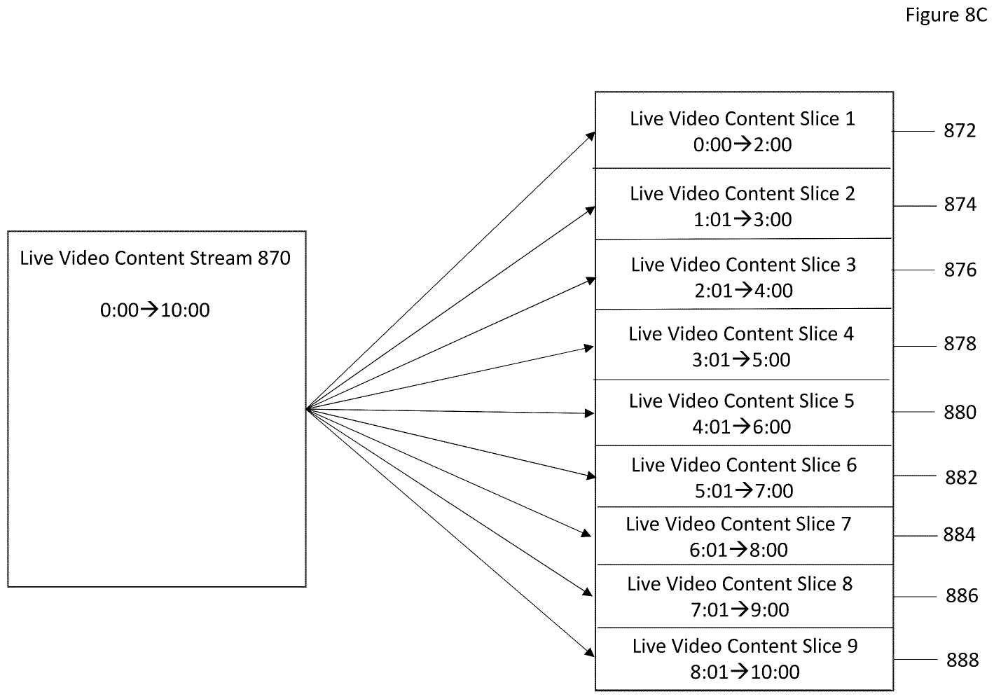

FIG. 8A depicts an exemplary sequence of steps to identify contextual information in near-real time in live content in an exemplary embodiment. The sequence begins by identifying live streams of content that are being delivered to a user device (step 802). For example, the live stream may be video content identified by monitoring an EPG for the occurrence of the beginning of the live stream or may result from a request from the calling application in the case of on demand streaming. Once identified the same stream of live content that is being delivered to the user device is downloaded (step 804). The stream of live content, for example a stream of live video content and its associated audio content, is segmented into slices of a pre-determined time period (step 806). Immediately upon the completion of the pre-determined time period for the slice, the slice is processed to identify contextual information within the slice in the manner described herein (or a similar technique) (step 808). For example, if the slice lasts two minutes the processing of the slice may commence immediately upon the end of that two minute slice. The contextual information may then be used to deliver or facilitate delivery of additional content for insertion into the stream of live content (step 810). For example, in one embodiment, a speech-to-text module and/or a video-to-text module, which may both be AI-based, may be used to identify keywords in the slice. Those keywords may then be used to identify additional content such as additional program information or contextual based advertising for insertion into the stream.

Slices can be assembled back-to-back with no content overlap between adjacent slices, or they can be assembled in an overlapping fashion, with all adjacent slices sharing some of the digital video content. For example, if the length of a slice is set at 2 minutes, 2-minute back-to-back slices may be assembled. In this case contextual information for the first 2-minute slice is available almost immediately after the slice is assembled. However, for the next 2 minutes, as the next slice is being assembled, even when the live content has been streamed to the 3 minutes and 59 seconds point, only contextual information from the first 0-2-minute slice is available, and that information becomes less relevant closer to the end of the subsequent slice. Overlapping slices can help to solve this problem. For example, for a slice with a two minute duration, a first slice may cover from 0-2 minutes of the live content first, then the next slice may cover 0:30-2:30 of the live content, then a next slice may cover 1-3 minutes of the live content, and so on until the end of the stream. This can reduce maximum lag to 30 seconds instead of 2 minutes. It should be appreciated that while the overlapping approach results in a more timely identification of contextual information, the tradeoff is that it requires more content processing and thus results in higher processing cost.

FIG. 8B depicts the segmenting of live video content into consecutive slices in an exemplary embodiment. The first 10 minutes of a live video content stream 850, such as a live sporting event or live news broadcast, is segmented into five live video content slices, 852, 854, 856, 858 and 860. The slices are captured consecutively with a new slice starting immediately after the conclusion of the preceding slice. Thus, for example, live video content slice 1 (852) captures the time period of 0:00 to 2:00 and live video content slice 2 (854) captures the time period of 2:01 to 4:00 in live video content stream 850. Each slice is analyzed for contextual information immediately following its capture. The identified contextual information is then used to identify relevant additional content for display during live video content stream 850.

FIG. 8C depicts the segmenting of live content into overlapping slices in an exemplary embodiment. Similarly to the example of FIG. 8B, a live video content stream 870 is segmented into multiple slices. However, unlike the example of FIG. 8B, live video content slices 872, 874, 876, 878, 880, 882, 884, 886 and 888 overlap in time. More particularly, the exemplary two minute slices are arranged to start in one minute intervals. For example, as depicted live video content slice 2 (874) starts at the 1 minute mark in the middle of the time period for live video content slice 1 (872), and live video content slice 3 (876) starts at the two minute mark in the middle of the time period for live video content slice 2 (874) and so forth. As noted above, this approach has the benefit of lessening the time between analysis of slices for contextual information so that more relevant additional content may be retrieved closer in time in the live stream to the related contextual information but comes at the cost of higher processing costs. It will be noted that the approach of FIG. 8B for a ten minute stream of content results in five two minute slices to be analyzed with new contextual information available in two minute intervals while the approach of FIG. 8C results in nine two minute slices for a ten minute stream of content but with new contextual information available in one minute intervals. In other embodiments, an even more granular approach may be used. For example, a two minute slice may be captured every thirty seconds resulting in the third slice which begins to be gathered at the 1:01 minute mark overlapping both the first and second slice which respectively begin at the zero second and thirty one second marks.

In one embodiment, to perform near real-time slicing to obtain relevant contextual information a trained machine learning model may be used. For example, an object detection model may be trained on known objects appearing in training videos. In another example, a music recognition module may be trained on known types of music and/or specific songs by known artists. It will be appreciated that the use of other sets of training data are also within the scope of the present invention. After training the machine learning model to identify contextual information, the trained model can be used to process each slice for contextual information. In other embodiments commercially available AI or ML models/services may be used.

### Throttling of Additional Content

When the additional content being supplied in response to a request is highly relevant contextually targeted advertisements, further concerns about properly dispersing the ads among different streaming platforms exist. Advertisers setting up campaign flights typically want to reach the widest audience possible. However, providers of EPG based streaming video vary widely in their reach and viewership, which translates to differences in the volume of simultaneous streams, and thus, contextual ad requests. If this disparity is not addressed, contextually targeted ads end up being served primarily to the largest EPG providers, with smaller EPG based streaming video providers getting significantly fewer ads.

Accordingly, in one embodiment, the dispersion of ads may be restricted based upon the identity of the requesting streaming platform to throttle/limit the inventory supply from the largest EPG-based streaming platforms so as to ensure contextually targeted ads do not end up being delivered disproportionately at the expense of the smaller streaming platforms and thereby inadvertently limit the advertisers reach. For example, for contextual advertising that uses keywords describing each scene or a time boxed chunk of video content, the rate at which such keywords can be retrieved for each ad request from each individual EPG-based streaming video provider can be pre-configured and adjusted statically or dynamically. This way the number of responses that contain targetable keywords per second for each EPG-based streaming video provider could be roughly the same or otherwise distributed according to predetermine parameters, thus resulting in a desired distribution of ads returned for each EPG based streaming video provider.

More particularly, in one embodiment static throttling may use a fixed ratio number (for example, an integer value between 0 and 100, or a floating-point number between 0.0 and 1.0) which defines for what percentage of requests such contextual targeting keywords (and thus ads) are retrieved. With static throttling, the fixed ratio number is preconfigured and is changed manually. For example, the static throttling ratio threshold may be set at 0.3 indicating that a single platform or a single entity controlling multiple platforms may have only 30% of its requests for contextually targeted ads processed during a pre-determined time period such as 1 hour. Continuing with the example, if streaming platform A submits 45 requests in a 1 hour block and 100 requests from all streaming platforms are received in the 1 hour time period the ratio threshold enforced by the analysis module that is set at 0.3 will dictate that only 30 of the 45 requests are satisfied using contextual information such as keywords to deliver relevant additional content, such as targeted advertisements, to streaming platform A, while the other 15 requests may be handled with default content or ignored depending upon pre-determined settings. As a result 70% of contextually targeted ads or other content is delivered to other platforms. It should be appreciated that in actuality the raw number of requests from the streaming platforms given in the example above would be magnitudes of order higher (e.g. tens of thousands) and the lower numbers in the example are given for ease of illustration of the throttling concept.

In an embodiment, dynamic throttling includes a feedback mechanism that constantly monitors and adjusts the throttling ratio to achieve the desired distribution rate across all EPG based streaming video providers. For example, if the total number of requests for contextually targeted ads for all streaming platforms increases beyond a pre-determined amount the ratio threshold may also be correspondingly increased as the danger of non-dispersal between platforms is lessened. Similarly, if the total number of requests for contextually targeted ads for all streaming platforms decreases beyond a pre-determined amount the ratio threshold may also be correspondingly decreased to limit the number of requests that will be processed as the total number of ads lessens and the danger of non-dispersal of ads between streaming platforms is increased.

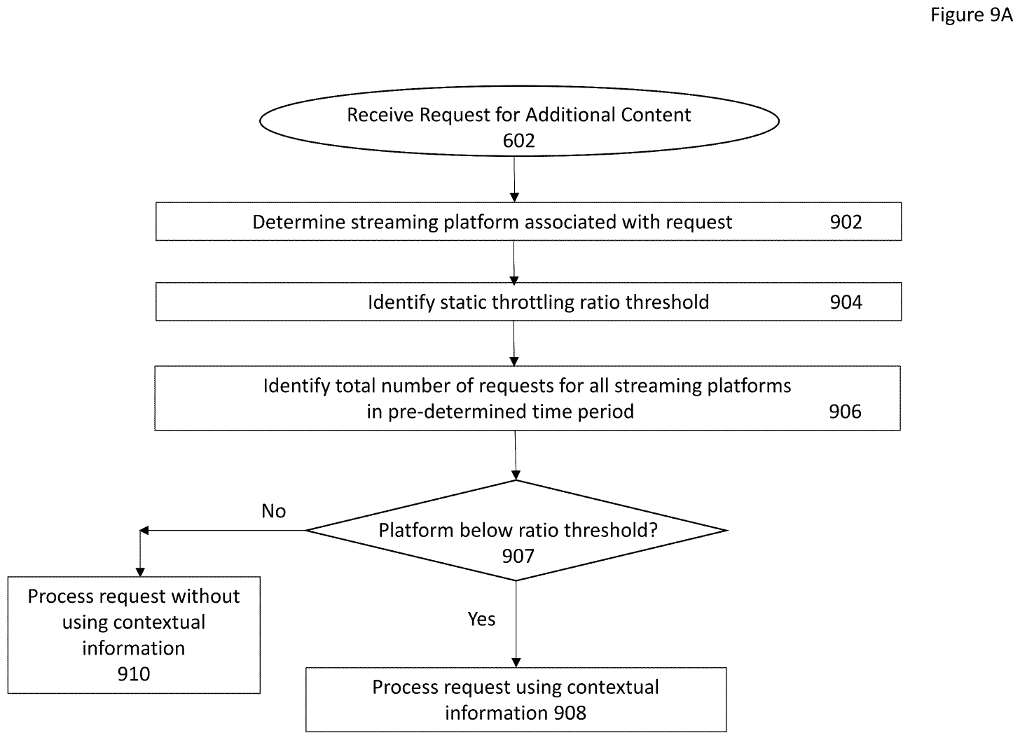

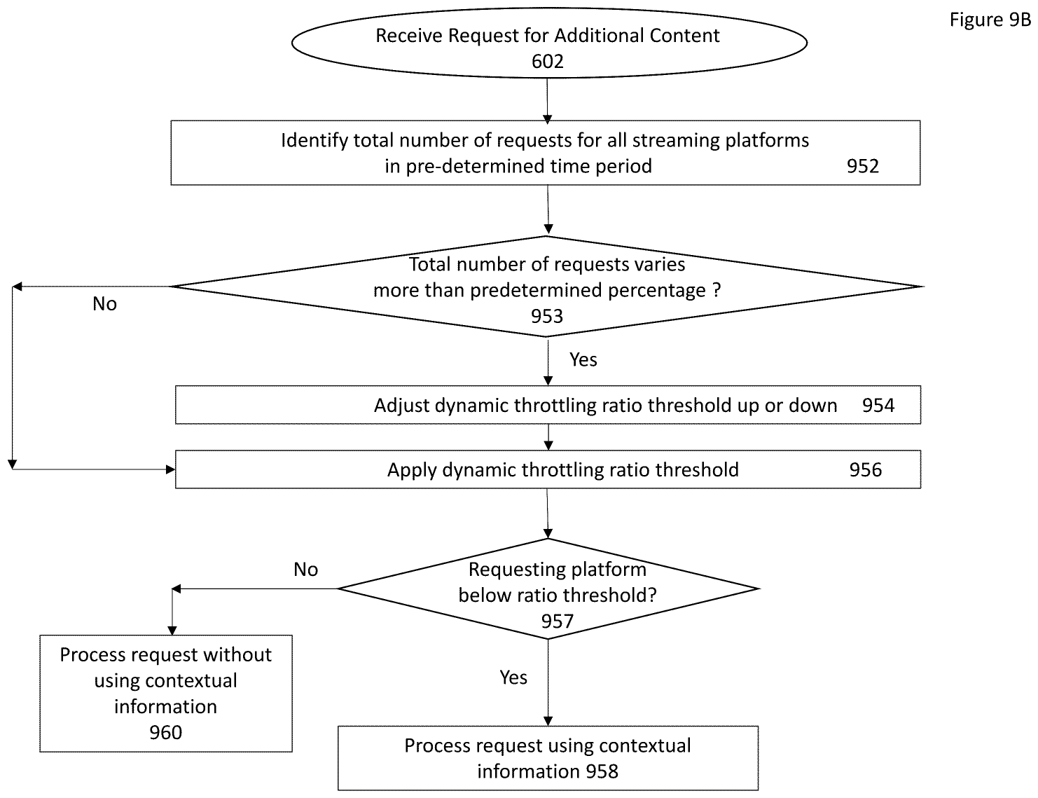

FIG. 9A depicts an exemplary sequence of steps to apply a static ratio throttling threshold to a request for additional content based on contextual information in an exemplary embodiment. When a request is received the streaming platform associated with the request is determined (step 902). The previously determined static throttling ratio threshold for that streaming platform is also identified (step 904). The total number of requests received for all streaming platforms over a pre-determined sliding time period is also monitored and identified (step 906). A determination is then made as to whether the specific platform associated with the request is below the static throttling ratio threshold (step 907). If so, the request may be processed using contextual information to supply additional content such as targeted advertisements based on relevant contextual information (step 908). If the particular streaming platform has made too many requests within the time period and therefore exceeds the ratio threshold the request is processed without using contextual information (step 910) such as by providing default content or ignoring the request based on a predetermined setting.

FIG. 9B depicts an exemplary sequence of steps to apply a dynamic throttling ratio threshold to a request for additional content based on contextual information in an exemplary embodiment. To handle a request for additional content based on contextual information for a particular streaming platform, the total number of requests received for all streaming platforms over a pre-determined sliding time period is monitored and identified (step 952). A determination is then made as to whether the total number of requests varies more than a predetermined percentage from an initial set total (step 953). If so, the dynamic throttling ratio threshold is adjusted up or down (step 954). For example, if the total number of requests in the time window is increasing over a certain percentage, the dynamic throttling ratio threshold may be lowered. Similarly, if the total number of requests in the time window is decreasing over a certain percentage, the dynamic throttling ratio threshold may be increased. If the total number of requests does not vary more than a predetermined percentage from the initial set total the dynamic throttling ratio threshold is not adjusted. The dynamic throttling ratio threshold is then applied to the request (step 956) and if the requesting platform is below the dynamic throttling ratio threshold (step 957), the request may be processed using contextual information to supply additional content such as targeted advertisements based on relevant contextual information (step 958). If the particular streaming platform has made too many requests within the time period and therefore exceeds the dynamic throttling ratio threshold the request is processed without using contextual information (step 960) such as by providing default content or ignoring the request based on a predetermined setting.

As further examples of FIGS. 9A and 9B, when handling requests from six EPG streaming providers where streaming providers A, B and C send significantly more requests to than providers D, E and F, throttling of the requests from streaming providers A, B and C may be necessary in order to evenly distribute ads or other additional content between the six EPG streaming providers. As noted above with respect to FIG. 9A, a distinct static throttling ratio threshold may be applied to each provider's requests based on the number of requests sent from each provider and the overall number of requests sent from all providers, resulting in a different throttling effect for each provider and an even distribution of handled requests (and therefore an even distribution of additional content such as contextually relevant targeted ads). Similarly, as noted with respect to FIG. 9B, a dynamic throttling ratio threshold may be dynamically adjusted and applied as the number of requests from the different streaming platforms varies so as to maintain an even distribution of handled requests.

By limiting the number of requests that will be answered for a single platform or platforms controlled by a single entity, embodiments significantly improve the distribution of contextually targeted ads between multiple EPG-based streaming video providers regardless of the volume of ad requests. In some embodiments, throttling may be applied to pre-scheduled EPG-based live digital video streaming on a Connected TV or an OTT device.

### Generalized Framework for Streaming Video Ingestion With Data Normalization

It should be appreciated that with multiple different entities controlling different streaming platforms that each have their own mechanisms for exposing data, ingesting that data for processing can be a significant challenge. The multiple providers of streaming TV that expose their linear streaming content via EPG do so in a manner that may be conceptually similar, but each may have their own proprietary format. For example, providers may provide the same channels but the identifying information may be different. Conventionally, it is necessary to ingest the video content from multiple EPGs (for example for contextual analysis) by ingesting and processing each specific EPG separately. This creates a significant technical implementation and maintenance overhead. Because EPGs from different providers include similar information in different formats, embodiments address this issue for pre-scheduled EPG-based live digital video streaming on a Connected TV or an OTT device. By providing an EPG ingestion and processing framework that is devised to facilitate the ability to encapsulate the common EPG ingestion and processing logic, only provider specific processing logic needs to be implemented separately for each specific EPG provider. In some embodiments using the framework, the processing is reduced by 30-50%.

EPGs include information about channel names, content showing time, show and episode names, URL to the actual streaming video (usually an adaptive bitrate streaming manifest for an HLS or a MPEG-DASH streaming content), rating, genre, and more. The generalized EPG ingestion and processing framework abstracts these common attributes and provides the foundation and APIs for individual EPG provider's EPG ingestion and processing implementation. For example, basic attributes that are usually sufficient to handle a request at runtime include, without limitation, channel name, channel description, movie title, sporting event title, show title, episode title, season, rating, genres (can be multiple genres such as comedy and drama), brief movie, episode, or sporting event description. Further optional additional attributes may include without limitation director, actors, first airing, etc. Different EPG streaming providers can name or structure these differently. It should be appreciated that the additional optional attributes (and some of the basic attributes) may or may not be present in specific EPGs.

Embodiments also generalize the retrieval of the media to which EPG entries point (programming items like TV show episodes, news shows, sporting event shows, movies, etc.) in the form of manifest and video segments, so such content can be analyzed and processed with AI-based tools. For example by extracting meaningful keywords describing each time boxed piece of the video content for purpose of contextual advertising targeting. The media to which the EPG points is retrieved and stored temporarily for processing. EPG entries usually contain URIs to the actual streaming media, that are accessed (manifest and segments), retrieved, sometimes decrypted, then temporarily re-assembled on servers to detect ad breaks and extract contextual information such as but not limited to contextual keywords. Generalizing the logic to perform these tasks removes the need to implement separate processes for each EPG provider.

The generalized logic covers multiple including:
EPG data processing and storing,
Manifest processing with periodic downloads and parsing as the manifests for live streaming content are open ended and only include a few segments that will be played next,
Ad break detection used in combination with additional EPG-provider specific logic than can be toggled on and off,
Logic to detect new programs that need to be processed versus re-runs that have already been processed;
A content AI processing pipeline that is shared between all EPG providers,
Channel name matching from incoming ad requests matching the names to information retrieved from the EPGs as the information in the request frequently includes extra or missing characters and or has extra text appended or prepended and so doesn't verbatim match the channel names from the EPGs.

Embodiments also include multiple generalized tools detecting ads in the video content, so the ads could be excluded from the original content when analyzing and processing the video content with AI-based tools. Different EPG providers may use different techniques to indicate ad breaks in their streams. They may not have such indicators at all for some channels. Embodiments use a generalized ad break detection logic that is configurable per EPG provider so specific ad detection techniques may be toggled on or off for each specific EPG provider. For example, the tools may first look for marked ad breaks for example breaks marked with SCTE-35 markers in manifests and video content. The tools may also look for patterns in content that change that indicate the presence of an ad. For example, the tools may look for discontinuities in the patterns of segment URLs and discontinuity in keyframes. In one embodiment, video can be analyzed using machine learning to detect changes in the scene and other factors that could indicate that it's a location where an ad is shown. The tools may also heuristically look for discontinuity.

It should be appreciated that because the content analysis and processing part of the ingestion framework described herein greatly simplifies and speeds up implementation of each individual EPG processing, it leads to better EPG-based video supply diversification with supply from multiple EPG providers for the purposes of advertising against such content, including contextual advertising targeting.

It should be appreciated that the embodiments described herein provide an improved content delivery mechanism in distributed networks. More particularly, embodiments optimize the insertion of additional highly relevant additional content based on contextual information into streams of content delivered over a network.

Portions or all of the embodiments of the present invention may be provided as one or more computer-readable programs or code embodied on or in one or more non-transitory mediums. The mediums may be, but are not limited to a hard disk, a compact disc, a digital versatile disc, a flash memory, a PROM, a RAM, a ROM, or a magnetic tape. In general, the computer-readable programs or code may be implemented in many computing languages.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel. Likewise, modules described as separate may be combined into a single module or separated into additional modules without departing from the scope of the present invention.

We claim:

1. A computing device-implemented method to identify contextual information in a stream of content being delivered by a streaming platform, the computing device including at least one processor, the method comprising:
receiving, at a server over a network, a request for additional content for insertion into a stream of content being delivered by a streaming platform to a user device;
downloading a stream of content corresponding to an identified program in the stream of content being delivered by the streaming platform;
identifying a plurality of upcoming media file segments in the stream of content for the identified program;
identifying contextual information in one or more of the plurality of upcoming media file segments;
storing a record of the identified contextual information that indicates a time of appearance of the contextual information in the stream of content;
identifying scheduled breaks in the plurality of upcoming media file segments;
mapping a time window of a pre-determined duration starting at a time of the request against the identified scheduled breaks in the plurality of upcoming media file segments;
determining whether stored contextual information exists for the stream of content for an upcoming break within the time window; and
delivering or facilitating the delivery of additional content to the requesting streaming platform using the contextual information to satisfy the request for additional content when the stored contextual information exists within the time window.

2. The method of claim 1, wherein the plurality of upcoming media file segments in the stream of content for the identified program are identified by examining a manifest or playlist for the identified program.

3. The method of claim 1, wherein the contextual information is identified using a speech-to-text module.

4. The method of claim 1, wherein the contextual information is identified using a video-to-text module.

5. The method of claim 1, wherein the contextual information is identified using a natural language processing module.

6. The method of claim 1, wherein the contextual information is identified using an object recognition module.

7. The method of claim 1, wherein the contextual information is identified using a music recognition module.

8. The method of claim 1, wherein the contextual information is identified using one or more of machine learning or artificial intelligence.

9. The method of claim 1, wherein at least one of the media file segments corresponds to a scene in the identified program or a pre-determined length of time in the identified program.

10. The method of claim 1, wherein the additional content is a public service announcement or nature scene.

11. The method of claim 1 wherein the additional content is additional information associated with the identified program.

12. The method of claim 1 wherein the additional content is an advertisement.

13. The method of claim 1, further comprising:
determining whether the stream of content is the same as a previously analyzed stream of content prior to downloading the stream of content corresponding to the identified program, the determining comparing a manifest for the stream of content corresponding to the identified program with a manifest for the previously analyzed stream, wherein the stream of content corresponding to the identified program is downloaded when the manifest comparison indicates the streams of content are not the same.

14. The method of claim 1, further comprising:
determining whether the stream of content is the same as a previously analyzed stream of content prior to identifying contextual information in one or more of the plurality of upcoming media file segments, the determining:
comparing content of a plurality of upcoming media file segments for the stream of content corresponding to the identified program with file segments for the previously analyzed stream, and
identifying contextual information for the stream of content corresponding to the identified program when the comparison indicates the streams of content are not the same.

15. The method of claim 1, further comprising:
establishing a pre-determined ratio threshold for handling all streaming platform requests for additional content using contextual information within a pre-determined period of time, the ratio indicating a threshold for a number of requests from a specific streaming platform in view of a total number of all streaming platform requests;
identifying the specific streaming platform delivering the stream of content;
determining a number of requests for additional content using contextual information received for the specific streaming platform within the pre-determined period of time;
comparing the number of requests to the pre-determined ratio threshold for all streaming platform requests within the pre-determined period of time; and
delivering or facilitating the delivery of additional content to the requesting streaming platform using the contextual information to satisfy the request for additional content when the number of requests for the specific streaming platform is below the ratio threshold.

16. The method of claim 15, wherein the ratio threshold is static.

17. The method of claim 15, wherein the ratio threshold is dynamic and programmatically adjusts based on a monitored number of requests received.

18. The method of claim 1, further comprising:
providing a framework for ingesting and processing Electronic Program Guide (EPG) information, the framework abstracting a plurality of attributes common to a plurality of EPG providers.

19. The method of claim 14, wherein the framework includes one or more generalized tools for detecting ad breaks in video content.

20. A non-transitory medium holding computing device-executable instructions for identifying contextual information in a stream of content being delivered by a streaming platform, the computing device including at least one processor, the instructions when executed causing at least one computing device to:
receive, at a server over a network, a request for additional content for insertion into a stream of content being delivered by a streaming platform to a user device;
download a stream of content corresponding to an identified program in the stream of content being delivered by the streaming platform;
identify a plurality of upcoming media file segments in the stream of content for the identified program;
identify contextual information in one or more of the plurality of upcoming media file segments;
store a record of the identified contextual information that indicates a time of appearance of the contextual information in the stream of content;
identify scheduled breaks in the plurality of upcoming media file segments;
map a time window of a pre-determined duration starting at a time of the request against the identified scheduled breaks in the plurality of upcoming media file segments;
determine whether stored contextual information exists for the stream of content for an upcoming break within the time window; and
deliver or facilitate the delivery of additional content to the requesting streaming platform using the contextual information to satisfy the request for additional content when the stored contextual information exists within the time window.

21. The medium of claim 20, wherein the plurality of upcoming media file segments in the stream of content for the identified program are identified by examining a manifest or playlist for the identified program.

22. The medium of claim 20, wherein the contextual information is identified using a speech-to-text module.

23. The medium of claim 20 wherein the contextual information is identified using a video-to-text module.

24. The medium of claim 20, wherein the contextual information is identified using a natural language processing module.

25. The medium of claim 20, wherein the contextual information is identified using an object recognition module.

26. The medium of claim 20, wherein the contextual information is identified using a music recognition module.

27. The medium of claim 20, wherein the contextual information is identified using one or more of machine learning or artificial intelligence.

28. The medium of claim 20, wherein at least one of the media file segments corresponds to a scene in the identified program or a pre-determined length of time in the identified program.

29. The medium of claim 20, wherein the additional content is a public service announcement or nature scene.

30. The medium of claim 20, wherein the additional content is additional information associated with the identified program.

31. The medium of claim 20, wherein the additional content is an advertisement.

32. The medium of claim 20, wherein the instructions when executed further cause the at least one computing device to:
determine whether the stream of content is the same as a previously analyzed stream of content prior to downloading the stream of content corresponding to the identified program, the determining comparing a manifest for the stream of content corresponding to the identified program with a manifest for the previously analyzed stream, wherein the stream of content corresponding to the identified program is downloaded when the manifest comparison indicates the streams of content are not the same.

33. The medium of claim 20, wherein the instructions when executed further cause the at least one computing device to:
determine whether the stream of content is the same as a previously analyzed stream of content prior to identifying contextual information in one or more of the plurality of upcoming media file segments, the determining:
comparing content of a plurality of upcoming media file segments for the stream of content corresponding to the identified program with file segments for the previously analyzed stream, and
identifying contextual information for the stream of content corresponding to the identified program when the comparison indicates the streams of content are not the same.

34. The medium of claim 20, wherein the instructions when executed further cause the at least one computing device to:
establish a pre-determined ratio threshold for handling all streaming platform requests for additional content using contextual information within a pre-determined period of time, the ratio indicating a threshold for a number of requests from a specific streaming platform in view of a total number of all streaming platform requests;
identify the specific streaming platform delivering the stream of content;
determine a number of requests for additional content using contextual information received for the specific streaming platform within the pre-determined period of time;
compare the number of requests to the pre-determined ratio threshold for all streaming platform requests within the pre-determined period of time; and
deliver or facilitate the delivery of additional content to the requesting streaming platform using the contextual information to satisfy the request for additional content when the number of requests for the specific streaming platform is below the ratio threshold.

35. The medium of claim 34, wherein the ratio threshold is static.

36. The medium of claim 34, wherein the ratio threshold is dynamic and programmatically adjusts based on a monitored number of requests received.

37. The medium of claim 20, wherein the instructions when executed further cause the at least one computing device to:
provide a framework for ingesting and processing Electronic Program Guide (EPG) information, the framework abstracting a plurality of attributes common to a plurality of EPG providers.

38. The medium of claim 37, wherein the framework includes one or more generalized tools for detecting ad breaks in video content.

39. A system for identifying contextual information in a stream of content being delivered by a streaming platform, comprising:
one or more network accessible storage locations holding additional content;
a network accessible computing device equipped with at least one processor, the network-accessible computing device including an analysis module, the analysis module when executed by the at least one processor configured to:
receive a request for additional content for insertion into a stream of content being delivered by a streaming platform to a user device;
download a stream of content corresponding to an identified program in the stream of content being delivered by the streaming platform;
identify a plurality of upcoming media file segments in the stream of content for the identified program;
identify contextual information in one or more of the plurality of upcoming media file segments;
store a record of the identified contextual information that indicates a time of appearance of the contextual information in the stream of content;
identify scheduled breaks in the plurality of upcoming media file segments;
map a time window of a pre-determined duration starting at a time of the request against the identified scheduled breaks in the plurality of upcoming media file segments;
determine whether stored contextual information exists for the stream of content for an upcoming break within the time window; and
deliver or facilitate the delivery of additional content from the one or more storage locations to the requesting streaming platform using the contextual information to satisfy the request for additional content when the stored contextual information exists within the time window.

40. The system of claim 39, wherein the contextual information is identified using one or more of a speech-to-text module, a video-to-text module, a natural language processing module, an object recognition module or a music recognition module.

41. The system of claim 40, wherein the contextual information is identified using one or more of machine learning or artificial intelligence.
